(19) United States
(12) Patent Application Publication
(10) Pub. No.: US 2026/0223774 A1
(43) Pub. Date: Aug. 6, 2026

(54) Mower Detection Zones

(71) Applicant: Autonomous Solutions, Inc., Mendon, UT (US)

(72) Inventors: Garrett Winward, Mendon, UT (US); Mckay Colleni, Mendon, UT (US); Jeff Ferrin, Mendon, UT (US); Levi Rupert, Mendon, UT (US); Taylor Bybee, Mendon, UT (US)

(73) Assignee: Autonomous Solutions, Inc., Mendon, UT (US)

(21) Appl. No.: 19/389,254

(22) Filed: Nov. 14, 2025

Related U.S. Application Data
(60) Provisional application No. 63/751,982, filed on Jan. 31, 2025.

(51) Int. Cl. A01D 34/00; G05D 1/243; G05D 1/622; G05D 1/65; G05D 105/15; G05D 107/20

(52) U.S. Cl. CPC A01D 34/008; G05D 1/243; G05D 1/622; G05D 1/65; G05D 2105/15; G05D 2107/21

(57) ABSTRACT

Disclosed are systems and methods for safely navigating an autonomous work vehicle by instructing the autonomous work vehicle to provide measured responses according to the proximity of an obstacle to the autonomous work vehicle. The response of the autonomous work vehicle may be determined based on a response set associated with one or more zones disposed around the autonomous work vehicle or about a selected navigational path. The response set may include warnings, such as activation of lights and/or alarms of the autonomous work vehicle, and/or motor actions, including reducing a velocity of the autonomous work vehicle, selecting another navigational path to avoid the obstacle, and/or adjusting the activation and/or position of an implement connected to the autonomous work vehicle. A response may be initiated when visual sensor signal data associated with a zone indicates the presence of an obstacle within the zone.

### BACKGROUND

For safe navigation through an operating environment, autonomous ground vehicles rely on sensory inputs such as cameras, LiDAR, and radar for detection and classification of obstacles and impassable terrain. These sensors provide data representing 3D space surrounding the vehicle. Obstacles present within the operating environment may be detected by the sensory inputs and may interfere with the safe and effective performance of an operational task of the autonomous work vehicle.

### SUMMARY

Disclosed are autonomous systems and methods for navigating an autonomous work vehicle, and more specifically for enabling an autonomous work vehicle to engage in measured responses to increase safe operation of the autonomous work vehicle while maintaining elevated operational efficiency. This may be enabled by defining one or more zones around the autonomous work vehicle. The autonomous work vehicle may comprise a steering control system for autonomously controlling a driving direction of the autonomous work vehicle and a speed control system for autonomously controlling a speed of the autonomous work vehicle. In some embodiments, the autonomous work vehicle may comprise an alert control system for autonomously controlling warning signals of the autonomous work vehicle. The autonomous work vehicle may additionally include one or more sensors, including a visual sensor, such as a LiDAR sensor. The autonomous work vehicle may be configured to perform an operational task within the operating environment. In some embodiments, an implement may be operationally connected to the autonomous work vehicle for performing a particular task. In some embodiments, the autonomous work vehicle can comprise an autonomous mower.

The autonomous work vehicle may further include one or more processors communicatively coupled with the one or more sensors, the steering control system, and the speed control system. One or more computer-readable media may store instructions of a method that when executed by the one or more processors that may operate the autonomous work vehicle.

The method may include receiving visual sensor signal data from the visual sensor in predetermined time packets, wherein the visual sensor signal data comprises data points of a virtual space that represents at least a portion of an operating environment, and assigning a subset of the data points of the visual sensor signal data to a series of nested zones. The series of nested zones may surround a portion of the virtual space representing a space occupied by the autonomous work vehicle. The series of nested zones may include, in order of increasing size, an occlusion zone, a hazard zone, a slowing zone, and a warning zone. The portion of the virtual space representing the space occupied by the autonomous work vehicle may be surrounded by each zone of the series of nested zones.

The method may include instructing the autonomous work vehicle to drive at a first velocity and instructing the autonomous work vehicle to respond when the visual sensor signal data indicates that an obstacle is present within a zone of the series of nested zones. The response of the vehicle may be specific to the zone in which the obstacle is located. When the visual sensor signal data indicates that an obstacle is present within the warning zone, the method may include instructing the alert control system to send a light beam or an audio alarm perceptible within the warning zone. When the visual sensor signal data indicates that an obstacle is present within the slowing zone, the method may include instructing the speed control system to slow a velocity of the autonomous work vehicle to a second velocity less than the first velocity. When the visual sensor signal data indicates that an obstacle is present within the hazard zone, the method may include instructing the speed control system to slow a velocity of the autonomous work vehicle to a third velocity less than the second velocity. When the visual sensor signal data indicates that an obstacle is present within the occlusion zone, the method may include instructing the speed control system to stop the autonomous work vehicle.

The method may further include instructing the speed control system to slow the velocity of the autonomous work vehicle at a greater deceleration in the hazard zone than in the slowing zone. The method may include adjusting a dimension of a zone of the series of nested zones based on the velocity and/or curvature of the autonomous work vehicle.

An outer limit of at least one zone of the series of nested zones may be spaced from the autonomous work vehicle by a set distance along a circumference of the autonomous work vehicle, such that the outer limit of the at least one zone resembles a top-view profile of the autonomous work vehicle. When the autonomous work vehicle is driven in reverse, an orientation of the series of nested zones may be mirrored about a lateral axis of the autonomous work vehicle.

The audio alarm may comprise a siren, a sound recording, or a horn of the autonomous work vehicle, and the light beam may comprise a flashing light or a continuous light. The method may include adjusting a position of an implement connected to the autonomous work vehicle when an obstacle enters the hazard zone.

Some embodiments of the method may include receiving visual sensor signal data from the visual sensor in predetermined time packets, wherein the visual sensor signal data comprises data points of a virtual space that represents at least a portion of an operating environment, and assigning a subset of the data points of the visual sensor signal data to a zone within the operating environment, wherein the zone surrounds a portion of the virtual space representing a space occupied by the autonomous work vehicle. The method may further comprise adjusting a dimension of the zone based on a velocity and/or curvature of the autonomous work vehicle, and may include instructing the speed control system to adjust a velocity of the autonomous work vehicle when an obstacle is detected within the zone.

The zone forms part of a series of nested zones surrounding the autonomous work vehicle, and the autonomous work vehicle may provide a different set of responses based on the zone within which the obstacle is detected. The method may include adjusting a dimension of the zone based on a position of an implement connected to the autonomous work vehicle. The method may include adjusting a position of an implement connected to the autonomous work vehicle when an obstacle is detected within the zone. The method may include mirroring an orientation of the zone about a lateral axis of the autonomous work vehicle when the autonomous work vehicle is driven in reverse.

Some embodiments of the method may include receiving visual sensor signal data from the visual sensor in predetermined time packets, wherein the visual sensor signal data comprises data points of a virtual space that represents at least a portion of an operating environment. The method may then include defining a first zone represented by a first polygon that surrounds a first portion of the virtual space corresponding to a space occupied by the autonomous work vehicle and assigning a first subset of the data points to the first zone, and defining a second zone represented by a second polygon that surrounds the first portion of the virtual space corresponding to the space occupied by the autonomous work vehicle and assigning a second subset of the data points to the second zone. The second polygon may have a smaller area than the first polygon. The method may then include, when an obstacle is detected within the first zone, instructing the speed control system to automatically slow the autonomous work vehicle, and when an obstacle is detected within the second zone, instructing the speed control system to automatically stop the autonomous work vehicle.

The method may further include adjusting a dimension of the first and/or second zone based on a velocity of the autonomous work vehicle. The method may include adjusting a dimension of the first and/or second zone based on a curvature of the autonomous work vehicle. The method can include mirroring the first and/or second zones about a lateral axis of the autonomous work vehicle when driven in reverse.

In some embodiments, the method may include defining a third zone represented by a third polygon that surrounds a second portion of the virtual space corresponding to at least a space extending along or to a side of a selected path of the autonomous work vehicle, and when an obstacle is detected within the third zone, instructing the speed control system to slow a velocity of the autonomous work vehicle to a target velocity before the obstacle enters the first zone. Additionally, or alternatively, the method may include, when an obstacle is detected within the first zone, instructing the speed control system to slow a velocity of the autonomous work vehicle at a greater deceleration in the first zone than when an obstacle is detected within in the third zone.

The method can include adjusting a position of an implement connected to the autonomous work vehicle when an obstacle enters the second zone. The method may include shutting down the autonomous work vehicle and/or an implement connected to the autonomous work vehicle when an obstacle enters the second zone.

These illustrative embodiments are mentioned not to limit or define the disclosure, but to provide examples to aid understanding. Additional embodiments are discussed in the Detailed Description, and further description is provided there. Advantages offered by one or more of the various embodiments may be further understood by examining this specification or by practicing one or more embodiments presented.

### BRIEF DESCRIPTION OF THE FIGURES

These and other features, aspects, and advantages of the present disclosure are better understood when the following Detailed Description is read with reference to the accompanying Drawings. In the Drawings, like reference numerals may be utilized to designate corresponding or similar parts in the various Figures, and the various elements depicted are not necessarily drawn to scale, wherein:

FIG. 1 shows an illustrative computational system for performing functionality to facilitate implementation of embodiments described in this document.

FIG. 2 illustrates a block diagram of an example autonomous work vehicle communication system of the present disclosure.

FIG. 3 is a side view of an autonomous yard truck according to some embodiments.

FIG. 4 is a perspective view of an autonomous mower according to some embodiments.

FIG. 5 is a side view of an autonomous tractor according to some embodiments.

FIG. 6 illustrates a schematic of a top view of an autonomous work vehicle comprising an autonomous mower.

FIG. 7 shows zones around an autonomous work vehicle, including (from largest to smallest): warning, slowing, stopping (hazard), and occlusion zones.

FIG. 8 show zones around an autonomous work vehicle that more closely approximate the profile of the autonomous work vehicle.

FIG. 9 illustrates a schematic of an autonomous work vehicle relative to the zones.

FIGS. 10 through 13 illustrate schematics of zones around an autonomous work vehicle at motion.

FIG. 14 shows a schematic of the projected path of slowing and hazard zones along a curve.

FIGS. 15A and 15B illustrate schematics of the orientation of the zones around the autonomous work vehicle in forward and reverse operation, respectively.

FIG. 16 shows a schematic of an autonomous work vehicle within an operating environment with various regions.

FIG. 17 shows a schematic of an autonomous work vehicle within an operating environment with a subset of the various regions following the curve of the vehicle path and/or instantaneous curvature of the autonomous work vehicle.

### DETAILED DESCRIPTION

Autonomous work vehicle systems rely on exteroceptive sensors to navigate an environment. For example, 2D or 3D scanning technologies (e.g., LiDAR or other visual sensor) can be used to generate a point cloud map or other representation of a sensor field of view within an operating environment. Obstacles within the operating environment may pose significant risks to the safe operation of the autonomous work vehicle. Obstacles detected by the sensors may be identified within the map or other representation of the sensor field of view and the navigational systems of the autonomous work vehicle may respond by selecting a path or adjusting a speed, acceleration, or direction that avoids or reduces the risk of collision between the autonomous work vehicle and the obstacle.

However, these responses may interfere with the efficient performance of the operational task by the autonomous work vehicle. For example, slowing a velocity of the autonomous work vehicle or interrupting the activity of a vehicle implement may increase the amount of time required for the autonomous work vehicle to perform the operational task. Additionally, abrupt slowing and speeding can make anticipation of vehicular movement difficult for bystanders and mitigate the ability of people to avoid the autonomous work vehicle during the operational task which can lead to further operational delays.

Not all obstacles present within the operating environment may pose the same level of risk of harm. For example, animate objects including animals and people may move across the selected path and within the vicinity of the autonomous work vehicle. This movement may be difficult to predict and plan for by the autonomous work vehicle navigational system. Stopping all operation of the autonomous work vehicle may have the greatest likelihood of avoiding harm to animate objects within the operating environment, but may unacceptably reduce operational efficiency.

Efficiency of the autonomous work vehicle, and the likelihood of operational success, may be increased by enabling the autonomous work vehicle to provide measured or restrained responses depending on the level of risk to the obstacle and/or autonomous work vehicle. The response of the autonomous work vehicle may be escalated or increased depending on the level of risk to operational safety. In particular, risk may be associated with the distance of the obstacle to the vehicle, with obstacles closer to the autonomous work vehicle posing greater risk than those that are positioned further away. Obstacles may be assigned to one or more navigational zones disposed around the autonomous work vehicle. When an obstacle is identified as being present within a zone the autonomous work vehicle may respond with the actions in a response set associated with the zone. The actions of the response set of a zone may escalate in severity with decreasing separation distance between the zone and the autonomous work vehicle.

In some embodiments, an autonomous work vehicle may sense obstacles around the vehicle, and, based only on autonomous work vehicle-based information, such as velocity, curvature, and on-vehicle sensors, slow and stop for obstacles prior to collision with the vehicle depending on where the obstacles are detected.

In some embodiments, a first and largest zone may be associated with a response set that aims to reduce the velocity of the vehicle, within a provided distance of travel. This may be achieved, for example, by measuring the longitudinal distance of an obstacle detected inside a zone to the vehicle and, given the travel distance between what is measured and an allowed distance to the obstacle from the vehicle at a given velocity, a control loop may be used to achieve the given velocity within that travel distance.

In some embodiments, a second zone that is smaller than the first may also be provided. The second zone may correspond to a response set that is similar to the first zone, except that when an obstacle is found within this zone, the distance that is provided will be used to control to a stop rather than a desired non-zero velocity. The controller maintaining this distance, for example, may also be allowed to apply greater deceleration than the first zone if it is necessary to achieve a stop within the measured distance to the obstacle. This second zone, for example, may be smaller than the first zone, but may still extend along the path of the vehicle, such that the autonomous work vehicle may respond by stopping for obstacles that are directly in the path, while the vehicle may not stop but mere slow for obstacles outside of the direct path of the vehicle (e.g., to maintain cautious operation around the obstacle).

Employing multiple navigational zones associated with different behavior, for example, may enable the autonomous work vehicle to maintain safe operating behavior, such as or stopping for obstacles in the path of the autonomous work vehicle and/or slowing for obstacles that are merely close to the path, without constantly or frequently employing aggressive deceleration behavior.

The autonomous work vehicle may sense obstacles in the operating environment, and based only on autonomous work vehicle-based information, such as velocity, curvature, and on-autonomous work vehicle sensors, perform different actions, such as slowing or stopping for obstacles, prior to collision with the autonomous work vehicle. In some embodiments, the autonomous work vehicle may respond without reliance on an external source or component (e.g., a path provided by a remote server or a user in order to slow and stop for obstacles).

As used herein, and unless specified elsewhere, the term “length” may refer to a dimension extending along the longitudinal axis L1 of the autonomous work vehicle and the term “width” refers to a dimension extending along the lateral axis of the autonomous work vehicle.

As used herein, the term “operational task” may refer to a task to be performed by the autonomous work vehicle. The task may require the use of an implement connected to the autonomous work vehicle and may require interfacing with a surface of the operating environment. In other embodiments, the operational task may comprise as its primary purpose transporting the autonomous work vehicle or the contents or load of the autonomous work vehicle to a different location.

As used herein, the term “obstacle” may refer to objects present within the operating environment. The objects may be animate (e.g., people or animals) or stationary (e.g., trees, buildings, or other fixtures). An obstacle may also comprise portions of the ground surface of the operating environment, such as steep terrain that is non-traversable or voids where no ground surface or other obstacles can be detected.

As used herein, the term “occlusion” may refer to a portion of the operating environment that is within the sensor field of view which is hidden by an object within the operating environment. For example, objects such as terrain (e.g., undulating terrain), atmospheric conditions (e.g., rain, fog, dust), or even portions of the autonomous work vehicle itself may occlude portions of the operating environment.

As used herein, the term “virtual space” may refer to a digital representation of a physical space (e.g., the operating environment occupied by the autonomous work vehicle) generated based on visual sensor signal data received from visual sensors (e.g., LiDAR, radar, or camera sensors). The virtual space may refer to a computer-simulated environment based on sensor data for representing the relationship between the autonomous work vehicle and the operating environment. The virtual space may enable the system to digitally reproduce the environment surrounding the autonomous work vehicle for successfully navigating the autonomous work vehicle around obstacles and along a path through the operating environment.

As used herein, the term “severe” or related terms may refer to a characteristic of the autonomous work vehicle response. More severe responses may have a greater intensity than less severe responses. More severe responses may represent larger changes in the current operation of the autonomous work vehicle than less severe responses. For example, a greater change in velocity (e.g., slowing to a smaller velocity) may be more severe than a smaller change in velocity (e.g., slowing to a greater velocity). In another example, playing a louder audio alert may be more severe than playing a less loud audio alert. The term “severe” or related terms may refer to the level of caution employed by the vehicle. For example, a slower velocity may be more severe than a faster velocity because the slower velocity is more cautious and less likely to induce harm or damage to the autonomous work vehicle or an obstacle.

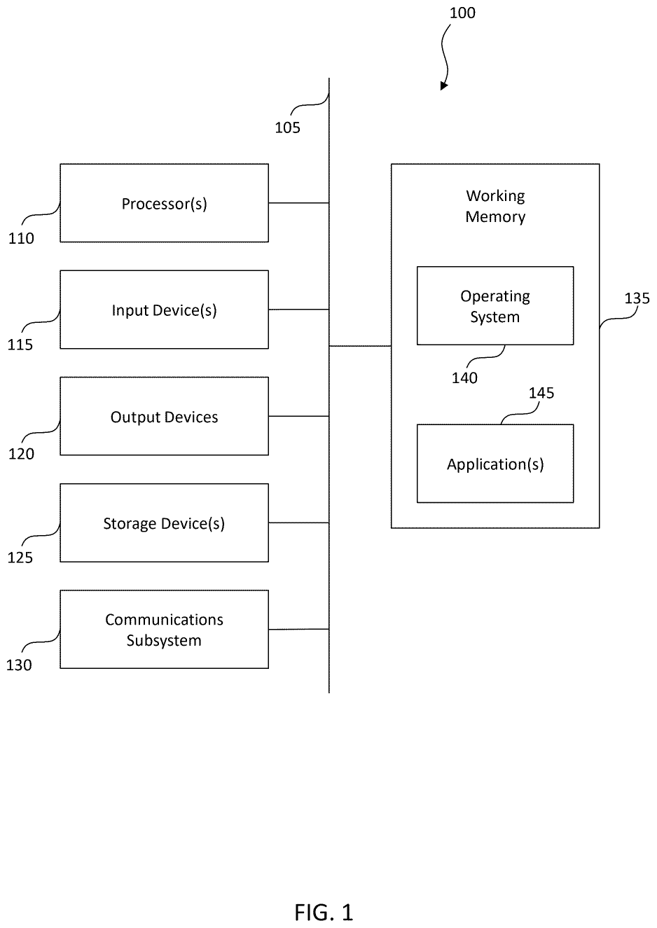

The computational system 100, shown in FIG. 1, can be used to perform any of the embodiments of the invention. As another example, computational system 100 can be used to perform any calculation, identification, and/or determination described here. Computational system 100 includes hardware elements that can be electrically coupled via a bus 105 (or may otherwise be in communication, as appropriate). The hardware elements can include one or more processors 110, including without limitation one or more general-purpose processors and/or one or more special-purpose processors (such as digital signal processing chips, graphics acceleration chips, and/or the like); one or more input devices 115, which can include without limitation a mouse, a keyboard, and/or the like; and one or more output devices 120, which can include without limitation a display device, a printer, and/or the like.

The computational system 100 may further include (and/or be in communication with) one or more storage devices 125, which can include, without limitation, local and/or network accessible storage and/or can include, without limitation, a disk drive, a drive array, an optical storage device, a solid-state storage device, such as a random access memory (“RAM”) and/or a read-only memory (“ROM”), which can be programmable, flash-updateable, and/or the like. The computational system 100 might also include a communications subsystem 130, which can include without limitation a modem, a network card (wireless or wired), an infrared communication device, a wireless communication device and/or chipset (such as a Bluetooth device, an 802.6 device, a Wi-Fi device, a WiMax device, cellular communication facilities, etc.), and/or the like. The communications subsystem 130 may permit data to be exchanged with a network (such as the network described below, to name one example), and/or any other devices described herein. In many embodiments, the computational system 100 will further include a working memory 135, which can include a RAM or ROM device, as described above.

The computational system 100 also can include software elements, shown as being currently located within the working memory 135, including an operating system 140 and/or other code, such as one or more application programs 145, which may include computer programs of the invention, and/or may be designed to implement methods of the invention and/or configure systems of the invention, as described herein. For example, one or more procedures described with respect to the method(s) discussed above might be implemented as code and/or instructions executable by a computer (and/or a processor within a computer). A set of these instructions and/or codes might be stored on a computer-readable storage medium, such as the storage device(s) 125 described above.

In some cases, the storage medium might be incorporated within the computational system 100 or in communication with the computational system 100. In other embodiments, the storage medium might be separate from a computational system 100 (e.g., a removable medium, such as a compact disc, etc.), and/or provided in an installation package, such that the storage medium can be used to program a general-purpose computer with the instructions/code stored thereon. These instructions might take the form of executable code, which is executable by the computational system 100 and/or might take the form of source and/or installable code, which, upon compilation and/or installation on the computational system 100 (e.g., using any of a variety of generally available compilers, installation programs, compression/decompression utilities, etc.) then takes the form of executable code.

The computational system 100 may be configured to operate an autonomous work vehicle platform. The term “autonomous work vehicle”, and related terms (e.g., “autonomous work vehicle platform”), as used herein may include manned vehicles, remote control vehicles, and/or manual vehicles, etc. The autonomous work vehicle platform may comprise a steering mechanism in communication with the processor, where the processor communicates steering commands to the steering mechanism based on the presence of an obstacle within a navigational zone (see description below). The autonomous work vehicle platform may comprise a braking mechanism in communication with the processor, where the processor communicates braking commands to the braking mechanism based on the presence of an obstacle within a navigational zone.

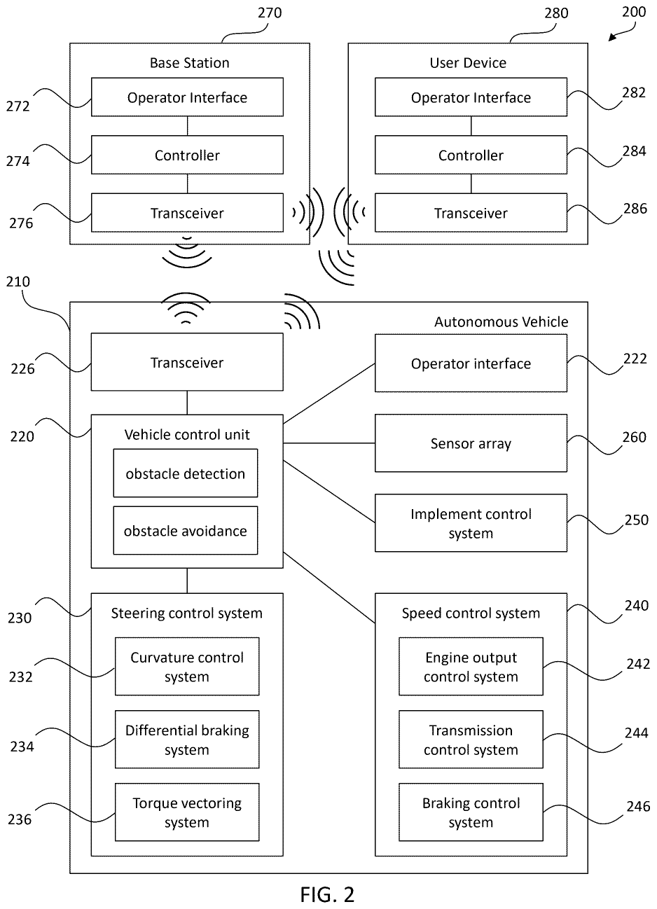

FIG. 2 is a block diagram of a communication and control system 200 that may be utilized in conjunction with the systems and methods of the disclosure. The communication and control system 200 may include a vehicle control unit 220 which may be mounted on an autonomous work vehicle 210. The autonomous work vehicle 210, for example, may include a yard truck, loader, wheel loader, track loader, dump truck, digger, backhoe, forklift, mower (e.g., lawn, field, or brush mower), or other vehicle. The communication and control system 200, for example, may include any or all components of computational system 100 shown in FIG. 1.

For example, the autonomous work vehicle 210 may include a steering control system 230 that may control a direction of movement of the autonomous work vehicle 210. The steering control system 230, for example, may include any or all components of computational system 100 shown in FIG. 1.

The autonomous work vehicle 210, for example, may include a speed control system 240 that controls the speed, acceleration, and deceleration of the autonomous work vehicle 210. The speed control system 240, for example, may control the speed of the autonomous work vehicle 210 based on map data, control algorithms, obstacle detection, start and/or stop points, input from the operator (e.g., a remote operator), etc. The speed control system 240, for example, may include any or all components of computational system 100 shown in FIG. 1.

The autonomous work vehicle 210, for example, may include an implement control system 250 that may control operation of an implement towed by the autonomous work vehicle 210, integrated within the autonomous work vehicle 210, or coupled to the autonomous work vehicle 210. The implement control system 250, for example, may include any type of implement such as, for example, a bucket, a shovel, a blade, a thumb, a dump bed, a plow, an auger, a trencher, a scraper, a broom, a hammer, a grapple, forks, boom, spears, a cutter, a wrist, a tiller, a rake, etc. The implement control system 250, for example, may include any or all components of computational system 100 shown in FIG. 1.

The vehicle control unit 220 may be communicatively coupled with the steering control system 230, the speed control system 240, and/or the implement control system 250. The vehicle control unit 220, for example, may include any or all of the components shown in FIG. 1. The vehicle control unit 220, for example, may be integrated into a single controller or may include a plurality of distinct components or controllers. The vehicle control unit 220 may also be coupled with one or more sensors from the sensor array 260 and receive sensor data from the sensor array 260.

The vehicle control unit 220, for example, may be used to control various aspects of the vehicle 210 such as, for example, sending instructions to the steering control system 230, implement control system 250, speed control system 240, etc. The vehicle control unit 220, for example, may include a vehicle artificial intelligence (VAI) that may include one or more processors that execute one or more algorithms.

The vehicle control unit 220, for example, may receive signals relative to many parameters of interest including, but not limited to: vehicle position, vehicle speed, vehicle heading, desired path location, off-path normal error, desired off-path normal error, heading error, vehicle state vector information, curvature state vector information, turning radius limits, steering angle, steering angle limits, steering rate limits, curvature, curvature rate, rate of curvature limits, roll, pitch, rotational rates, acceleration, and the like, or any combination thereof. These signals, for example, may come from the sensor array 260 or from a base station 270 (described below).

The vehicle control unit 220, for example, may be an electronic controller with electrical circuitry configured to process data from the various components of the autonomous work vehicle 210. The vehicle control unit 220 may include a processor, such as the processor 110, and a working memory 135. The vehicle control unit 220 may also include one or more storage devices, storage media, and/or other suitable components of computational system 100. The processor may be used to execute software, such as software for calculating drivable path plans. Moreover, the processor may include multiple microprocessors, one or more “general-purpose” microprocessors, one or more special-purpose microprocessors, and/or one or more application specific integrated circuits (ASICS), or any combination thereof. For example, the processor may include one or more reduced instruction set (RISC) processors. The vehicle control unit 220, for example, may include any or all the components shown in FIG. 1.

The vehicle control unit 220, for example, may include a volatile memory, such as random access memory (RAM), and/or a nonvolatile memory, such as ROM (e.g., working memory 135, storage device 125, and/or other computer-readable media). The memory may store a variety of information and may be used for various purposes. For example, the memory may store processor-executable instructions (e.g., firmware or software) for the vehicle control unit 220 to execute, such as instructions for calculating a drivable path plan, and/or controlling the autonomous work vehicle 210. The memory may include flash memory, one or more hard drives, or any other suitable optical, magnetic, or solid-state storage medium, or a combination thereof. The memory may store data such as field maps, maps of desired paths, vehicle characteristics, software or firmware instructions, and/or any other suitable data.

The steering control system 230, for example, may include a curvature rate control system 232, a differential braking system 234, a steering mechanism, and a torque vectoring system 236 that may be used to steer the autonomous work vehicle 210. The curvature rate control system 232, for example, may control a direction of an autonomous work vehicle 210 by controlling a steering control system of the autonomous work vehicle 210 with a curvature rate, such as an Ackerman style autonomous work vehicle, 210 or articulating vehicle. The curvature rate control system 232, for example, may automatically rotate one or more wheels or tracks of the autonomous work vehicle 210 via hydraulic or electric actuators to steer the autonomous work vehicle 210. By way of example, the curvature rate control system 232 may rotate front wheels/tracks, rear wheels/tracks, and/or intermediate wheels/tracks of the autonomous work vehicle 210 or articulate the frame of the vehicle, either individually or in groups. The differential braking system 234 may independently vary the braking force on each lateral side of the autonomous work vehicle 210 to direct the autonomous work vehicle 210. Similarly, the torque vectoring system 236 may differentially apply torque from the engine to the wheels and/or tracks on each lateral side of the autonomous work vehicle 210. While the illustrated steering control system 230 includes the curvature rate control system 232, the differential braking system 234, and the torque vectoring system 236, the steering control system 230 may include one or more of these systems. Further examples may include a steering control system 230 having other and/or additional systems to facilitate turning the autonomous work vehicle 210 such as an articulated steering control system, a differential drive system, and the like.

The speed control system 240, for example, may include an engine output control system 242, a transmission control system 244, and a braking control system 246. The engine output control system 242 may vary the output of the engine to control the speed of the autonomous work vehicle 210. For example, the engine output control system 242 may vary a throttle setting of the engine, a fuel/air mixture of the engine, a timing of the engine, and/or other suitable engine parameters to control engine output. In addition, the transmission control system 244 may adjust gear selection within a transmission to control the speed of the autonomous work vehicle 210. Furthermore, the braking control system 246 may adjust the braking force to control the speed of the autonomous work vehicle 210. While the illustrated speed control system 240 includes the engine output control system 242, the transmission control system 244, and the braking control system 246, the speed control system 240 may include one or two of these systems. The speed control system 240, for example, may also include other systems and/or additional systems that may be used to control the speed of the autonomous work vehicle 210.

The implement control system 250, for example, may control various parameters of the implement towed by and/or integrated within the autonomous work vehicle 210. For example, the implement control system 250 may instruct an implement controller via a communication link, such as a CAN bus, ISOBUS, Ethernet, wireless communications, and/or Broad R Reach type Automotive Ethernet, etc.

The implement control system 250, for example, may instruct an implement controller to adjust a penetration depth of at least one ground engaging tool of an agricultural implement, which may reduce the draft load on the autonomous work vehicle 210.

The implement control system 250, as another example, may instruct the implement controller to transition an agricultural implement between a working position and a transport portion, to adjust a flow rate of product from the agricultural implement, to adjust a position of a header of the agricultural implement (e.g., a harvester, etc.), among other operations, etc. The implement control system 250, as another example, may instruct the implement controller to adjust a shovel height, a shovel angle, a shovel position, etc.

The communication and control system 200, for example, may include a sensor array 260. The sensor array 260, for example, may facilitate determination of condition(s) of the autonomous work vehicle 210 and/or the work area. For example, the sensor array 260 may include one or more sensors (e.g., infrared sensors, ultrasonic sensors, magnetic sensors, tachometer, radar sensors, LiDAR sensors, terahertz sensors, sonar sensors, wheel encoders, cameras, etc.) that monitor a rotation rate of a respective wheel and/or track a ground speed of the autonomous work vehicle 210. The sensors may also monitor operating levels (e.g., temperature, fuel level, etc.) of the autonomous work vehicle 210. Furthermore, the sensors may monitor conditions in and around the work area, such as temperature, weather, wind speed, compass, humidity, and other conditions. The sensors of the sensor array 260, for example, may detect physical objects in the work area, such as a parking stall, a material stall, accessories, other vehicles, obstacles, environmental features, or other object(s) that may be in the area surrounding the autonomous work vehicle 210.

The sensor array 260, for example, may include a velocity sensor which may include one or more of an inertial measurement unit, a compass, a GPS sensor, a wheel encoder, a tachometer, a camera, a radar, etc. The sensor array 260, for example, may also include a steering angle sensor. The velocity sensor, for example, may produce velocity data. Velocity data may include information regarding speed and/or bearing. Velocity data, for example, may additionally, or alternatively, include information regarding the steering angular rate.

The autonomous work vehicle 210 may include an operator interface 222 for controlling the vehicle. The operator interface 222, for example, may be communicatively coupled to the vehicle control unit 220 and configured to present data from the autonomous work vehicle 210 via a display. Display data may include data associated with operation of the autonomous work vehicle 210, data associated with operation of an implement, a position of the autonomous work vehicle 210, a speed of the autonomous work vehicle 210, a desired path, a drivable path plan, a target position, and/or a current position, etc. The operator interface 222 may enable an operator to control certain functions of the autonomous work vehicle 210 such as starting and stopping the autonomous work vehicle 210, inputting a desired path, etc. The operator interface 222, for example, may enable the operator to input parameters that cause the vehicle control unit 220 to adjust the drivable path plan. For example, the operator may provide an input requesting that the desired path be acquired as quickly as possible, that an off-path normal error be minimized, that a speed of the autonomous work vehicle 210 remain within certain limits, and/or that a lateral acceleration experienced by the autonomous work vehicle 210 remain within certain limits, etc. In addition, the operator interface 222 (e.g., via the display, or via an audio system (not shown), etc.) may alert an operator if the desired path cannot be achieved, for example.

The communication and control system 200, for example, may include a base station 270 having a base station controller 274 located remotely from the autonomous work vehicle 210. For example, the control functions of the vehicle control unit 220 may be distributed between the vehicle control unit 220 of the autonomous work vehicle 210 and the base station controller 274. The base station controller 274, for example, may perform a substantial portion of the control functions of the vehicle control unit 220. For example, a first transceiver 226 positioned on the autonomous work vehicle 210 may output signals indicative of vehicle characteristics (e.g., position, speed, heading, curvature rate, curvature rate limits, maximum turning rate, minimum turning radius, steering angle, roll, pitch, rotational rates, acceleration, etc.) to a second transceiver 276 at the base station 270. The base station controller 274, for example, may calculate drivable path plans and/or output control signals to control the curvature control system 232, the speed control system 240, and/or the implement control system 250 to direct the autonomous work vehicle 210 toward the desired path, for example. The base station controller 274 may include a processor and memory device having similar features and/or capabilities as the processor and the memory device discussed previously. Likewise, the base station 270 may include an operator interface 272 having a display, which may have similar features and/or capabilities as the operator interface 222 and the display discussed previously.

In some embodiments, one or both of the base station 270 and/or the autonomous work vehicle 210 may be in communication with a user device 280. A user device 280 may include a phone, tablet, laptop, or computer. The user device 280 may similarly include an operator interface 282 which may include similar features and capabilities as operator interfaces 222, 272 described above. Additionally, or alternatively, the user device 280 may comprise a controller 284 that may include the same or similar features, components, and/or characteristics as the controller 274 of the base station 270. For example, the user device controller 274 may calculate drivable path plans, output control signals to control the curvature control system 232, the speed control system 240, and/or the implement control system 250 to direct the autonomous work vehicle 210. The user device 280, for example, can include an application that allows the user (e.g., a remote operator) to communicate commands to the autonomous work vehicle 210 (e.g., via a transceiver 286) and/or receive information about the autonomous work vehicle 210. Alternatively, or additionally, the user device 280, for example, can include an application that allows the operator to observe the autonomous work vehicle 210 move through a map of the work area where the autonomous work vehicle operates.

The user device 280, for example, may include an application that can receive an indication associated with the remote operator or which can receive other user or operator inputs. The user device 280, for example, may include an application that can display any of the information disclosed in this document.

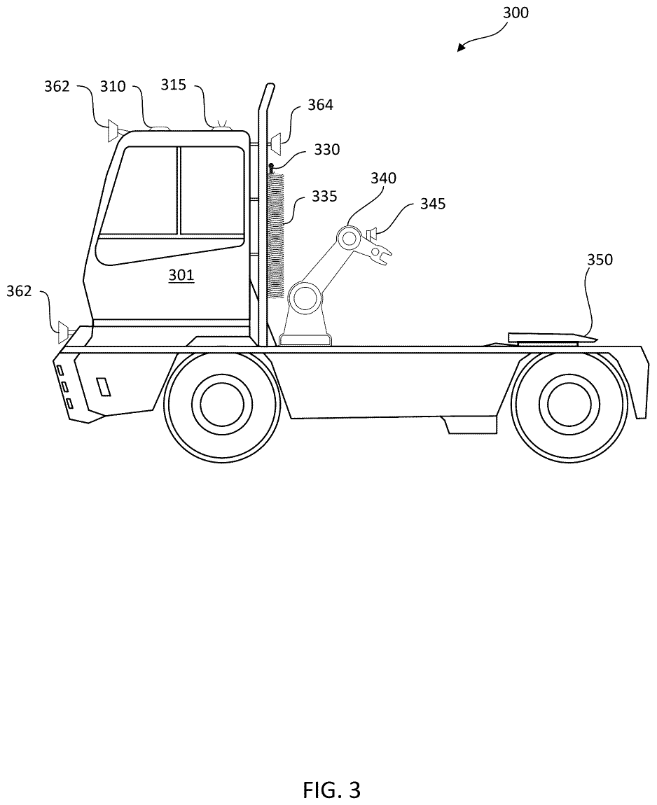

FIG. 3 is a side view of an autonomous yard truck 300 according to some embodiments. The autonomous yard truck 300 includes a cab 301 that may be used to drive the autonomous yard truck 300 manually. The autonomous yard truck 300 may include one or more of the components shown in FIG. 2. The autonomous yard truck 300 may also include a brake system, an engine, a transmission, steering, sensor array, etc. such as, for example, as shown in FIG. 2.

In some embodiments, the autonomous yard truck 300 may include a sensor array that includes sensors 362 (e.g., sensor array 260) disposed at various locations on the autonomous yard truck 300 such as, for example, on the cab 301, bumper, housing, frame, etc. The sensors 362 may include infrared sensors, ultrasonic sensors, magnetic sensors, radar sensors, LiDAR sensors, terahertz sensors, sonar sensors, cameras, etc. The sensor array of the autonomous yard truck 300 may also include one or more backup sensors 364 such as, for example, infrared sensors, ultrasonic sensors, magnetic sensors, radar sensors, LiDAR sensors, terahertz sensors, sonar sensors, cameras, etc.

In some embodiments, the autonomous yard truck 300 may include a spatial locating device (or GPS) antenna 310. In some embodiments, the autonomous yard truck 300 may include a transceiver antenna 315.

In some embodiments, the autonomous yard truck 300 may include one or more hoses 335 that can connect with a trailer such as, for example, two or three hoses. Each hose may have a hose connector 330 that can connect with a trailer hose connector. For example, the one or more hoses 335 of the autonomous yard truck 300 may include a service brake hose, an emergency brake hose, and/or a refrigerant hose.

In some embodiments, the autonomous yard truck 300 may include a robotic arm 340 disposed on the back bed of the autonomous yard truck 300. The robotic arm 340 may include any type of robotic arm. The robotic arm 340, for example, may exert high torque or high pressure sufficient to connect the hose connector 330 with the trailer hose connector. The hose connector 330 and/or the trailer hose connector may comprise a glad-hand connector. In some embodiments, when the autonomous yard truck 300 is not coupled with a trailer, the hose connector 330 may be positioned in a storage rack at some point on the autonomous yard truck 300 such as, for example, on the rear of the cab 301.

In some embodiments, the robotic arm 340 may include one or more arm sensors 345 such as, for example, infrared sensors, ultrasonic sensors, magnetic sensors, radar sensors, LiDAR sensors, terahertz sensors, sonar sensors, cameras, etc. The arm sensor 345, for example, may produce data that can be used to identify the location of a hose connector 330 and/or a trailer hose connector. The arm sensor 345, for example, may produce data that can show that a hose connector 330 and/or a trailer hose connector are sufficiently coupled.

In some embodiments, the autonomous yard truck 300 may include a fifth-wheel coupling 350. The fifth-wheel coupling 350, for example, may be raised or lowered with a fifth-wheel coupling boom. FIG. 3 shows the fifth-wheel coupling 350 in a lowered position. The fifth-wheel coupling 350 may couple with a kingpin of a trailer.

When the fifth-wheel coupling 350 is coupled with a kingpin and the fifth-wheel coupling 350 is in the raised position, the legs of the trailer may lift off the ground (e.g., automatically). This may allow the autonomous yard truck 300 to pull the trailer without individually raising the trailer legs.

In some embodiments, the robotic arm 340 and/or the arm sensor 345 may be coupled with a thermal management system. A thermal management system may, for example, be coupled with a thermal management system associated with the autonomous yard truck 300 such as, for example, coupled with the cab heating/cooling system and/or the engine heating/cooling system. A thermal management system may, for example, be an independent system that heats and/or cools the robotic arm 340 and/or the arm sensor 345. A thermal management system may, for example, keep the temperature of the robotic arm 340 and/or the arm sensor 345 between about 32° F. and about 100° F.

In some embodiments, the autonomous yard truck 300 may include a deployable shade coupled with the back of the cab 301. The deployable shade, for example, may be used to screen the sun and/or other lighting from the arm sensor 345 and/or the one or more backup sensors 364. The deployable shade, for example, may include an umbrella configuration or an awning configuration. The deployable shade, for example, may be coupled with the roof or an upper portion of the cab.

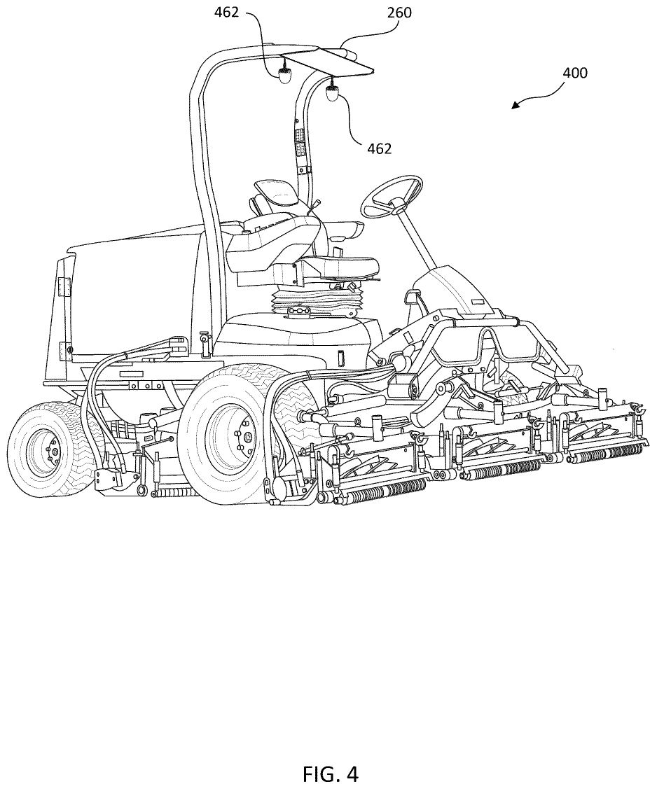

FIG. 4 is a sideview of an example autonomous mower 400, which may include all or some of the components of autonomous work vehicle 210. The autonomous work vehicle in this document may include the autonomous mower 400. Any type of mower or blades may be used, such as a disc mower. The autonomous mower 400, for example, may include a sensor array 260 (or multiple sensor arrays 260), including sensors 462. The sensor array 260 may include, for example, one or more LiDAR, radar, and/or video cameras. The video cameras, for example, may include 360 degree cameras, a front facing camera, and/or a back facing camera.

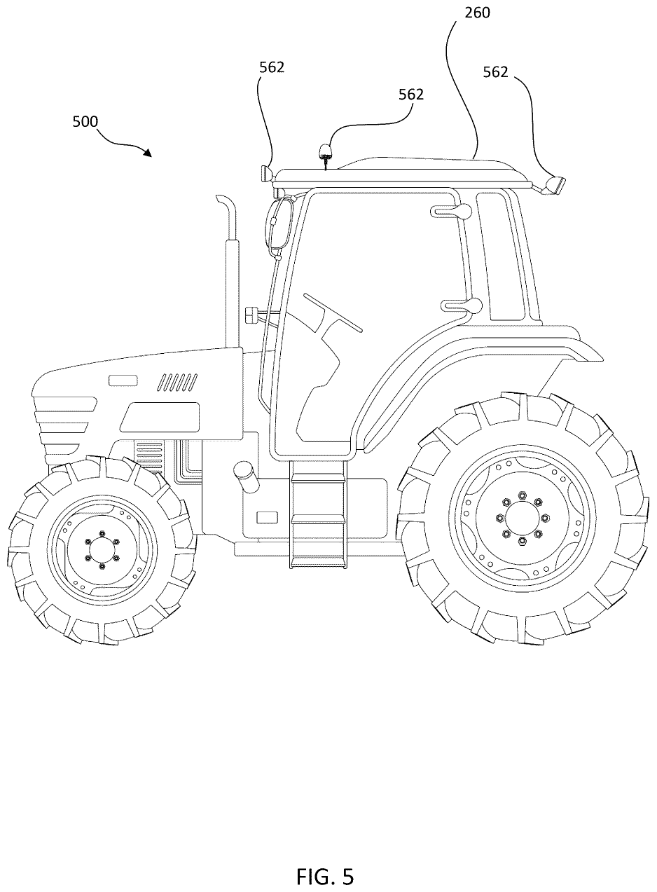

FIG. 5 is a sideview of an example autonomous tractor 500, which may include all or some of the components of autonomous work vehicle 210. The autonomous work vehicle in this document may include the autonomous tractor 500. In this example, the autonomous tractor 500 may include standard tractor equipment and/or components. The autonomous tractor 500 may include or be coupled with any kind of implement such as, for example, a plow, disc plow, reel mower, dumper, lift, bucket, shovel, blade, and/or cutter, etc. The autonomous tractor 500, for example, may include a sensor array 260 (or multiple sensor arrays 260), including sensor(s) 562. The sensor array 260 may include, for example, one or more LiDAR, radar, and/or video cameras. The video cameras, for example, may include 360 degree cameras, a front facing camera, and/or a back facing camera.

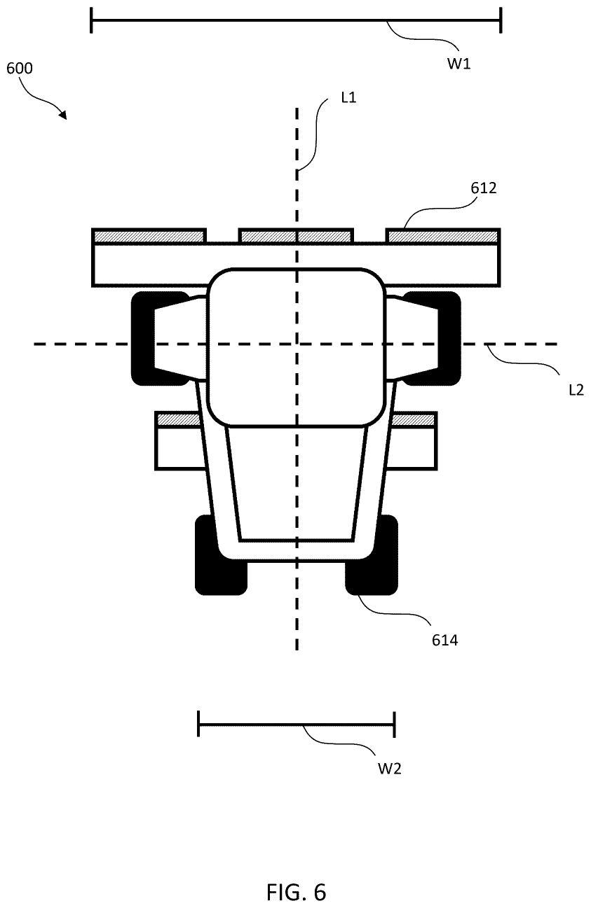

FIG. 6 illustrates a top view of an autonomous work vehicle 600 comprising an autonomous mower. However, the autonomous work vehicle 600 may include other types of vehicles, such as an autonomous tractor or an autonomous yard truck, as described previously. To reiterate, the autonomous work vehicle may include a steering control system for autonomously controlling a driving direction of the autonomous work vehicle, and a speed control system for autonomously controlling a speed of the autonomous work vehicle. The autonomous work vehicle 600 may additionally, or alternatively, comprise an alert control system for autonomously controlling warning signals of the autonomous work vehicle 600.

The autonomous work vehicle 600 may include one or more sensors, including a visual sensor. The visual sensor may include a LiDAR sensor, a camera (e.g., a stereo camera), a radar sensor, or other visual sensor configured to produce signals that represent portions of the operating environment. The visual sensor (e.g., LiDAR sensor) may produce visual sensor signal data (e.g., point cloud data) comprised of data points and send them to the autonomous work vehicle in predetermined time packets, which may be used to generate a map representation of the operating environment. The visual sensor signal data may comprise data points of a virtual space that represents at least a portion of the operating environment. The autonomous work vehicle 600 may comprise a first width W1 at the front of the autonomous work vehicle 600 and a second width W2 at the rear of the autonomous work vehicle 600. In some embodiments, the first and second widths W1, W2 may be similar. In other embodiments, and as depicted in FIG. 6, the first and second widths W1, W2 may be different. For example, in the case of an autonomous mower, the first width W1 at the front of the vehicle 600 may be greater than the second width at the rear of the vehicle 600. A longitudinal axis L1 may extend along a center of the autonomous work vehicle 600 from a front end 612 towards a rear end 614 of the vehicle 600. A lateral axis L2 may extend along a center of the autonomous work vehicle 600 from a left side to a right side of the vehicle 600.

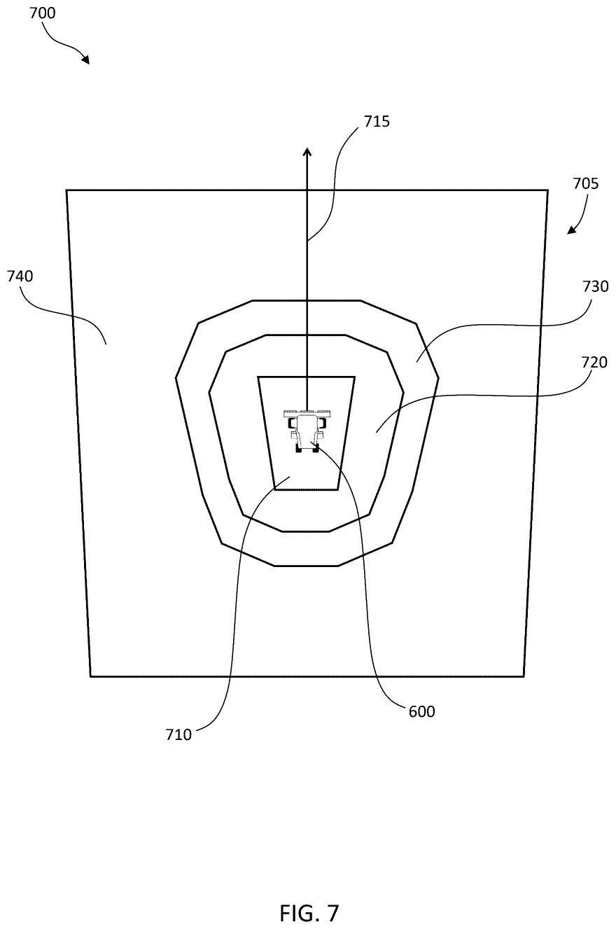

FIG. 7 illustrates a diagram 700 including an autonomous work vehicle 600 inside a plurality of zones 705. The zones 705 may comprise a shape or outline that surrounds a portion of a virtual space representing a space (e.g., a space surrounding the autonomous work vehicle) within the operating environment. The zones 705 may comprise polygons present within a map space that represents the operating environment. The zones 705 may be used to elicit a response from the autonomous work vehicle 600 when an obstacle (or other phenomena described below), as indicated within the virtual space, are detected within the zones 705. When visual sensor signal data is received from the visual sensor, each data point of the visual sensor signal data (e.g., point cloud data from a LiDAR sensor) may be assigned to a region within a zone or to region falling outside the zones. When data points of the visual sensor signal data indicate an obstacle is identified as present within a zone, the autonomous work vehicle 600 may perform a response that corresponds to the particular zone containing the obstacle.

The zones 705 may represent regions within the operating environment that surround or lie in proximity to the autonomous work vehicle 600. The zones 705 may be fixed relative to the autonomous work vehicle 600, such that movement of the autonomous work vehicle 600 during driving also moves the zones 705 through the operating environment. An obstacle entering a zone 705 (e.g., as one or more zones 705 move to include the obstacle, or as the obstacle moves within the region of the zone 705) may trigger a response from the autonomous work vehicle 600. The response may be particular to the zone 705 which the obstacle enters and response associated with each zone 705 can include a distinct set of actions. Conversely, when an obstacle leaves a zone 705, the autonomous work vehicle 600 may revert to behavior preempted by the response associated with the zone 705 or may perform actions previously limited by the response set of the zone 705. For example, when an obstacle enters a zone 705 the autonomous work vehicle 600 may slow to a first velocity at or below a velocity threshold, and after the obstacle leaves the zone 705 the autonomous work vehicle 600 may accelerate to a second velocity above the velocity threshold, such as a previous velocity of the autonomous work vehicle 600.

At least a subset of the data points of the visual sensor signal data may be assigned to one or more zones 705. The zones 705 may represent a portion of the operating environment, and the data points of the visual sensor signal data may each be associated with one or more zones 705. As the autonomous work vehicle 600 travels through the operating environment and/or as the dimensions of the zones 705 are adjusted the data points may be re-assigned or associated with a different zone. When the data points indicate the presence of an obstacle within an associated zone, the autonomous work vehicle 600 may be instructed to respond according to a response set associated with the zone in which the obstacle is present.

The data points of the visual sensor signal data may be associated with two or more zones 705. That is, the zones 705 may overlap within the virtual space. When data points belonging to multiple zones indicate the presence of an obstacle within the multiple zones, the autonomous work vehicle 600 may respond with the actions of each of the multiple zones 705 to which the data points belong.

Sometimes, the response set of multiple zones may conflict. For example, each zone may include a response comprising a different target velocity. In such instances, the vehicle may implement the severest (e.g., safest) or highest-priority response of the conflicting responses. For example, if two zones overlap and the zones include conflicting responses, such as a first target velocity and a second target velocity lower than the first target velocity, the speed control system may be instructed to slow a velocity of the autonomous work vehicle 600 to the second target velocity, with the second target velocity being the more severe response in that it requires the slowest velocity and/or a larger change from the initial velocity of the autonomous work vehicle 600.

Additionally, or alternatively, the slower target velocity may be identified as higher-priority over the first target velocity. For example, each of the zones 705 may be assigned a priority, and the responses of zones 705 with higher priority may implemented over responses from lower-priority zones 705 when the response conflict (i.e., when both responses cannot be implemented simultaneously). For example, a first zone having outer limits lying closer to the autonomous work vehicle 600 may have a higher priority than a second zone having outer limits lying further from the autonomous work vehicle 600, and the responses of the first zone may have a higher priority over the responses of the second zone, such that the responses of the first zone are implemented when they conflict with the responses of the second zone.

The zones 705 may form part of a series of nested zones, such that the zones 705 are disposed one within another. The zones 705 may comprise one zone or may comprise multiple zones 705, such as first zone 710, second zone 720, third zone 730, and fourth zone 740. The space occupied by the autonomous work vehicle 600 represented within the virtual space may be surrounded by each zone 705 of the series of nested zones. The autonomous work vehicle 600 may be positioned at the center of the series of nested zones.

The form of the zones 705 may resemble a polygon. In some embodiments, the zone 705 may have a quadrilateral shape, such as a square, rectangular, trapezoidal, or a rhomboidal shape. In other embodiments, the zone 705 may not have a quadrilateral shape. For example, the zone 705 may comprise a round (e.g., circular, elliptical, oval), triangular, or pentagonal profile, or other polygonal profile. The zone 705 may comprise a polygon having 5, 6, 7, 8, 9, 10, 11, 12, or more than 12 sides. The polygonal profile of the zone 705 need not comprise equal-length sides or equal-sized angles. The zone 705 may comprise an irregular shaped profile.

In some embodiments, the shape of the zone 705 may resemble a profile or outline (when viewed from above) of the autonomous work vehicle 600. For example, in instances such as those shown in FIG. 7, the autonomous work vehicle 600 may be an autonomous mower that may have a first width W1 that is greater towards a front end 612 than a second width W2 at a rear end 614. Similar to the dimensions of the autonomous work vehicle 600 described above, the zones 705, such as zones 710, 720, 730, 740, may also have a width that is greater towards a front end 612 than at a rear end 614 of the autonomous work vehicle 600. More particularly, the zones 705 may have dimensions that are proportional to the dimensions of the autonomous work vehicle 600.

The shape of the zone 705 may loosely resemble the profile of the autonomous work vehicle 600. For example, first zone 710 and fourth zone 740 may loosely resemble the profile of the autonomous work vehicle 600 in that they may resemble a trapezoid having a width that is greater towards a front than towards a back of the autonomous work vehicle 600. The zones 705, such as second zone 720 and third zone 730, may more closely resemble the profile of the autonomous work vehicle 600 as irregular-shaped decagons (10-sided polygon).

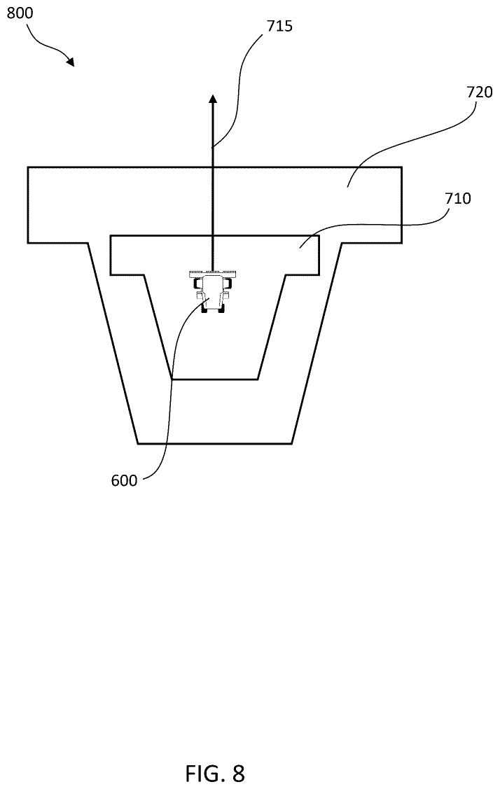

FIG. 8 illustrates that the zones 705 may more specifically resemble the profile of the autonomous work vehicle 600. For example, the zones 705 may resemble the profile of the autonomous work vehicle 600 and an implement (e.g., a mower reel) attached to the autonomous work vehicle 600. In some embodiments, an outer limit of at least one zone 705 of the series of nested zones is spaced around the autonomous work vehicle by a set distance from the autonomous work vehicle 600 along a circumference of the autonomous work vehicle 600, such that the outer limit of the at least one zone 705 resembles a top-view profile of the autonomous work vehicle 600.

The zones 705 (returning to FIG. 7), such as second zone 720 and third zone 730, may be spaced around (i.e., may extend outwards from) the autonomous work vehicle 600 by approximately the same distance (i.e., a set distance). The set distance may vary according to the particular zone. For example, the outer limit of the second zone 720 may extend outwards from the autonomous work vehicle 600 by a set distance of approximately 1, 2, 5, 6, 8, 10, 12, 15, or 20 feet, or within a range having any two of the foregoing values as endpoints. The third zone 730 may have an outer limit that extends outwards from the autonomous work vehicle 600 by a set distance of approximately 5, 8, 10, 15, 20, 25, 30, 40, or 50 feet, or within a range having any two of the foregoing values as endpoints.

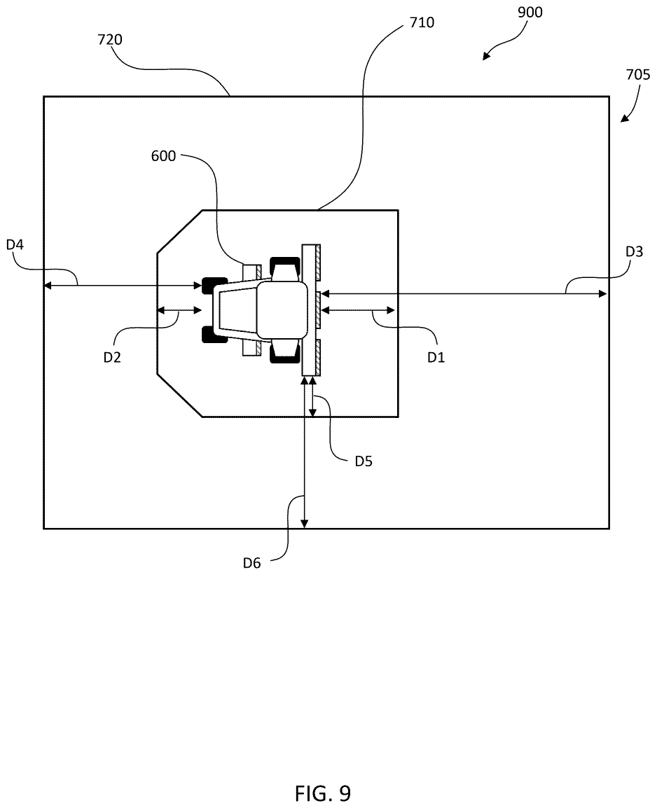

FIG. 9 illustrates a zone diagram 900 showing that the autonomous work vehicle 600 may be asymmetrically positioned within the surrounding zones 705. For example, the autonomous work vehicle 600 may be oriented symmetrically along a longitudinal axis L1 of the autonomous work vehicle 600 within the surrounding zones 705. The autonomous work vehicle 600 may be oriented asymmetrically along a lateral axis L2 of the autonomous work vehicle 600 within the surrounding zones 705, such that the autonomous work vehicle 600 is situated closer to a rear end than to a front end of the one or more zone 705, or vice versa.

The zones 705 comprise only two zones—first zone 710 and second zone 720—that surround the autonomous work vehicle 600. The first zone 710 may comprise an irregular-shaped heptagon while the second zone 720 may comprise a rectangular shape. The first zone 710 may loosely resemble the profile of the autonomous work vehicle 600 in that it narrows towards the rear end 614 of the autonomous work vehicle 600 similar to how to the profile of the autonomous work vehicle 600 narrows towards a rear end 614.

The autonomous work vehicle 600 may be positioned offset between the front and rear ends of the first and second zones 710, 720 (i.e., positioned asymmetrically with respect to a lateral axis L2 of the autonomous work vehicle 600 or non-aligned with a lateral axis L2 of the zones 705). For example, a first distance D1 between the front end 612 of the autonomous work vehicle 600 and the front limit of the first zone 710 may be greater than a second distance D2 between a rear end 614 of the autonomous work vehicle 600 and the rear limit of the first zone 710. Similarly, a third distance D3 between the front end 612 of the autonomous work vehicle 600 and the front limit of the second zone 720 may be greater than a fourth distance D4 between a rear end 614 of the autonomous work vehicle 600 and the rear limit of the second zone 720. This may enable the autonomous work vehicle 600, when driven in a forwards direction, greater time to slow a velocity of the autonomous work vehicle 600 when encountering an obstacle towards the front of the autonomous work vehicle 600. Such time may not be as necessary for detecting obstacles behind the autonomous work vehicle 600 as the autonomous work vehicle 600 will typically be moving away from the obstacle if detected towards the rear of the autonomous work vehicle 600. However, portions of the zones 705 extending behind the autonomous work vehicle 600 may still be necessary for detecting obstacles traveling towards the autonomous work vehicle 600.

The zones 705 may extend laterally away from the sides of the autonomous work vehicle 600 by a fifth distance D5 and a sixth distance D6 to the lateral limits of the first and second zones 710, 720, respectively. The distances between the autonomous work vehicle 600 and the first and second zones 710, 720 may be proportionally related at constant ratios. For example, the first distance D1 may extend to a length of 1, 1.1, 1.2, 1.3, 1.4, 1.5, 2.0, 2.5, or 3.0 times the length of the second distance D2, or may extend to a length within a range having any two of the foregoing as endpoints. A similar relationship may apply between the third distance D3 and the fourth distance D4, respectively.

In another example, the third distance D3 may extend to a length of 1.2, 1.5, 2.0, 2.5, 3.0, 3.5, 4.0, 4.5, or 5.0 times the length of the first distance D1, or may extend to a length within a range having any two of the foregoing as endpoints. Additionally, or alternatively, a similar relationship may apply between the fourth distance D4 and the second distance D2, respectively.

The zones 705 may extend or grow depending on the movement of an implement connected to the autonomous work vehicle 600. For example, the distance D5 may extend further to a first side of the autonomous work vehicle 600 than on an opposite side when an implement (e.g., a boom) is positioned towards the first side of the autonomous work vehicle 600.

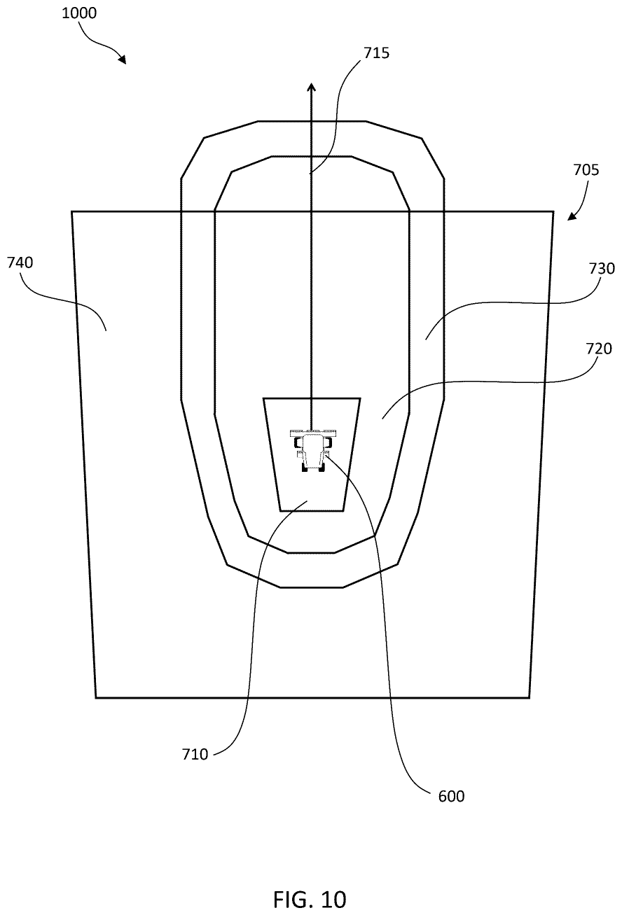

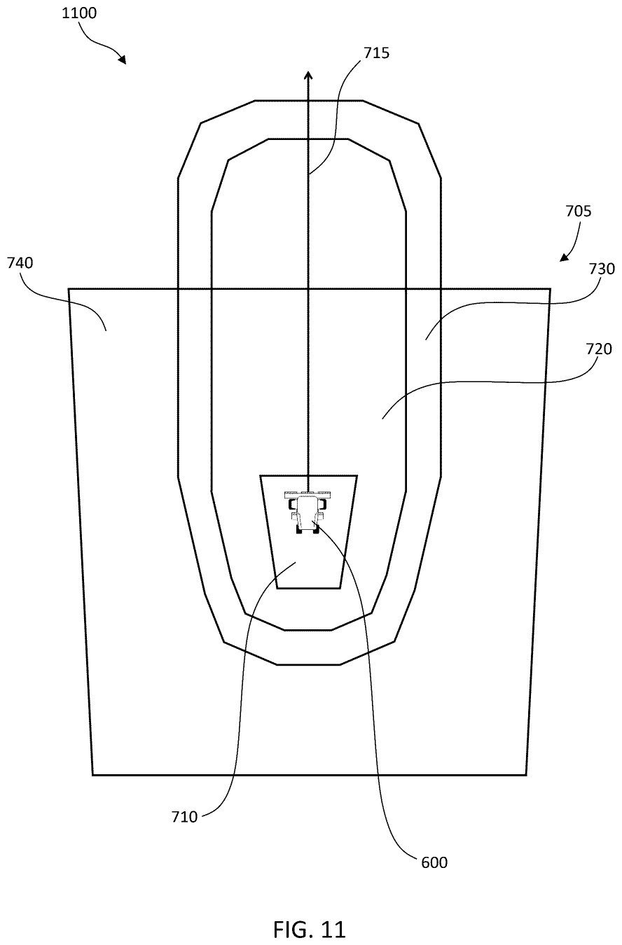

FIGS. 10 and 11 illustrate zone diagrams 1000, 1100 and show that at least one dimension of at least some of the zones 705 (e.g., second zone 720 and third zone 730) may be adjusted based on a parameter of the autonomous work vehicle. For example, the length of the second and third zones 720, 730 may increase as the velocity of the autonomous work vehicle 600 increases. Thus, FIG. 11 illustrates the second and third zones 720, 730 when the autonomous work vehicle 600 is driving at a velocity greater than that of the autonomous work vehicle 600 in FIG. 10, such that the length of the second and third zones 720, 730 is greater in FIG. 11 than in FIG. 10. In some embodiments, the length of the second and third zones 720, 730 (or other zones) may be based on a maximum deceleration capability of the autonomous work vehicle 600. For example, the length of the second and third zones 720, 730 may be based on the distance required for the autonomous work vehicle 600 to stop, the instantaneous velocity of the autonomous work vehicle, and the maximum deceleration capability of the autonomous work vehicle 600. In other embodiments, the length of the second and third zones need not be based on the maximum deceleration capability of the autonomous work vehicle 600.

In some embodiments, the width at least some of the zones 705 (e.g., second zone 720 and third zone 730) may vary according to the velocity of the autonomous work vehicle 600 in a manner similar to adjustments made to the length of at least some of the zones 705. A width of the any of the zones 705 may increase (e.g., uniformly or non-uniformly) with increasing distance from the autonomous work vehicle 600. For example, the width of any and/or all of the zones 705 may be adjusted to a greater extent towards the front limit of the zone than towards a rear limit of the zone.

The dimensions of the zones 705 may be adjusted based on a position or mode of an implement. For example, a length of the zones 705 may increase when an implement comprising a mower reel is active and cutting a ground surface of the operating environment. This may enable the autonomous work vehicle 600 to spend additional resources (e.g., computing power), for example, scanning the zones 705 for obstacles, only when needed, such as at times when increased care is needed (e.g., when the risk of harm is greater). Conversely, this enables the autonomous work vehicle 600 to reduce the use of resources when risk of harm is comparably less.

The dimensions of the zone 705 may additionally, or alternatively, depend on a mode of the autonomous work vehicle 600. The modes may include a transport mode (wherein the autonomous work vehicle is operating to arrive at the location of the operational task), and one or more operational modes (wherein the autonomous work vehicle is performing the operational task). The operational modes may vary depending on the safety of the performance of the task to nearby obstacles (e.g., when the autonomous work vehicle 600 is actively controlling an implement). For example, the zones 705 may have a smaller length and/or width when the autonomous work vehicle 600 is in transport mode and may have a comparatively greater length and/or width when the autonomous work vehicle 600 is in an operational mode.

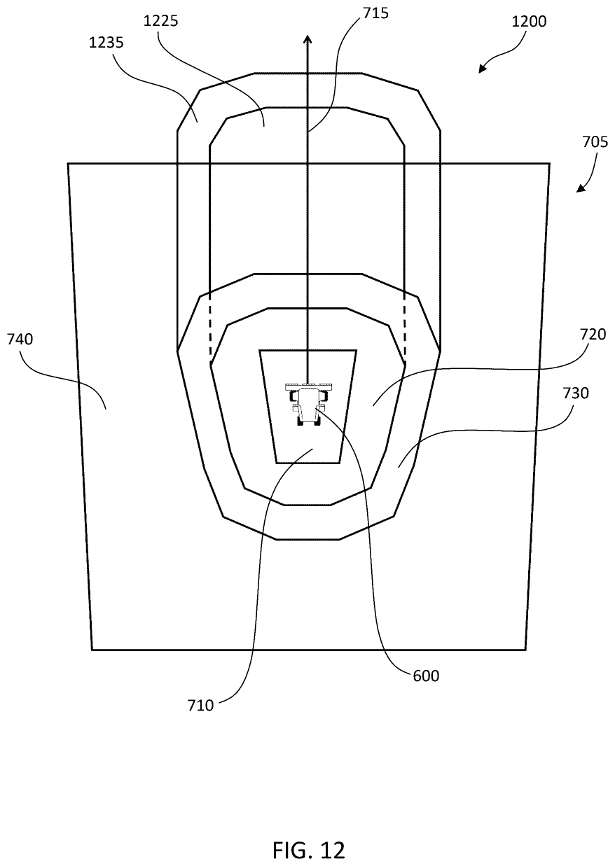

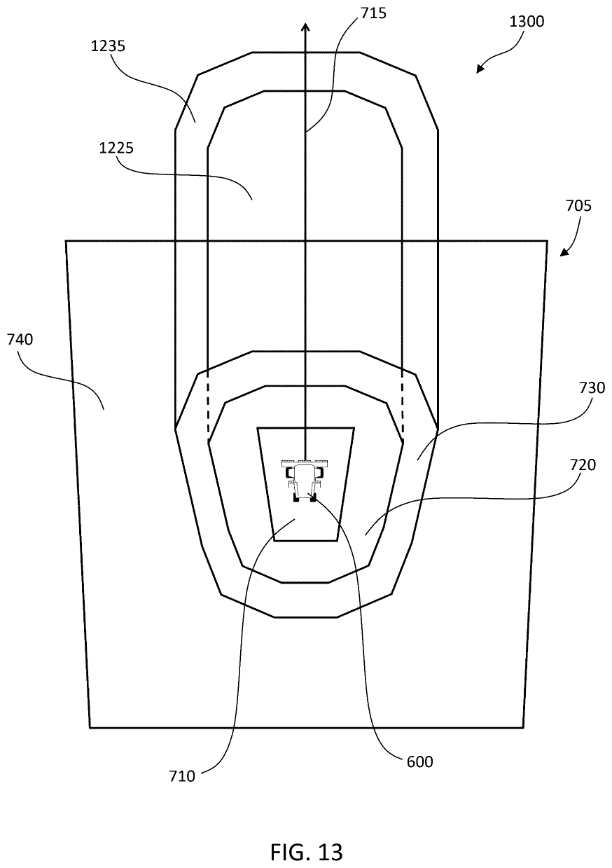

FIGS. 12 and 13 show an alternative embodiments of zone diagrams 1200, 1300, and illustrate that the zones 705 may include zones that do not surround the autonomous work vehicle 600, but which are disposed in front of the autonomous work vehicle 600 and/or along a selected path 715. The zones 705 may include principal zones, which may comprise zones 710, 720, 730, 740 described previously, and may additionally include extension zones, such as fifth zone 1225 and sixth zone 1235, that extend from a zone of the zones 705. The fifth zone 1225 may extend from the second zone 720 and the sixth zone 1235 may extend from the third zone 730. The dimensions of the extension zones may depend on a parameter of the autonomous work vehicle 600, such as the velocity of the autonomous work vehicle 600, whereas the dimensions of the principal zones (i.e., zones 710, 720, 730, 740 in this example) may remain constant, at least with regard to the parameter upon which adjustment of the extension zones is based.

The extension zones may adjust relative to the principal zones among one or more dimensions, including a length and a width (e.g., a variable width along a length of the extension zone). Thus, the length of the extension zones, including the fifth and sixth zones 1225, 1235, may vary according to a velocity of the autonomous work vehicle 600, with FIG. 13 showing the autonomous work vehicle 600 at a velocity greater than that of the autonomous work vehicle 600 in FIG. 12.

The extension zones may simplify processing and handling of the zones by the autonomous work vehicle system. As described more fully below, each of the extension zones may be associated with a corresponding principal zone, such that the response of the autonomous work vehicle 600 is the same or similar for an extension zone as for a corresponding principal zone.

The extension zones may overlap with portions of the principal zones. Each extension zone may share a profile, or a portion of a profile (e.g., the shape of the front limit) of a principal zone. For example, the fifth and sixth zones 1225, 1235 of the extensions zones may have a greatest width that is equal to the greatest width of the second and third zones 720, 730, respectively.

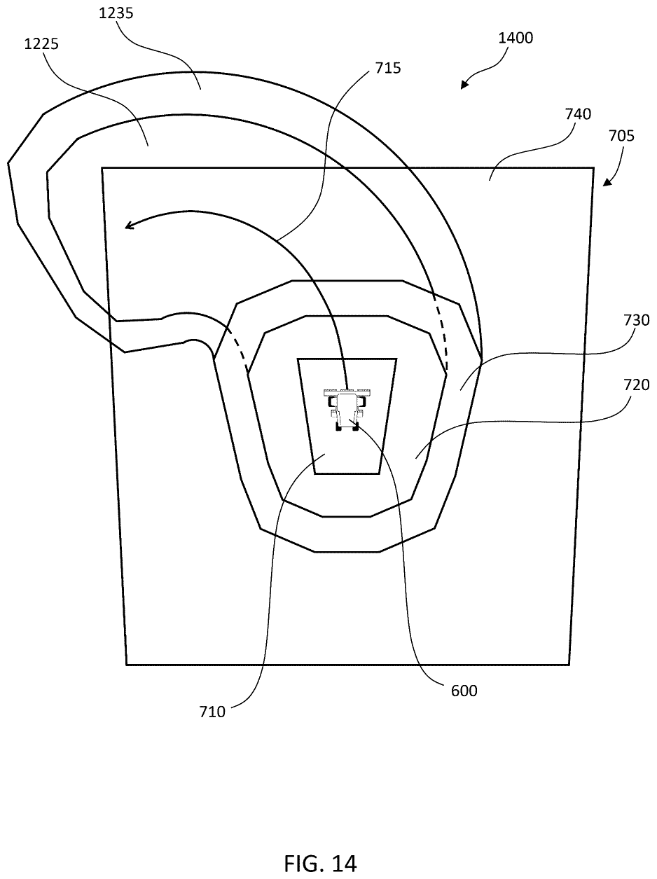

FIG. 14 illustrates a zone diagram 1400 wherein the selected path 715 continues in front of the autonomous work vehicle 600 along a curve, such that the selected path 715 does not follow a straight line. In such instances, a dimension of a zone of the zones 705 may be adjusted based on a curvature of the autonomous work vehicle 600 as it is driven along the selected path 715. For example, the zones 705 may be curved based on a curvature of the autonomous work vehicle. In an example, the extension zones, such as fifth and sixth zones 1225, 1235, may follow the curve of the selected path 715. In some embodiments, following the curve of the selected path 715 may mean that a center line following the center of the extension zone may align with the selected path 715. In other embodiments, the extension zone may follow the curve of the selected path 715 such that the selected path is within the extension zone along the length of the zone. This may enable the autonomous work vehicle system to better search for obstacles that are more likely to interfere with operation of the autonomous work vehicle 600.

In some embodiments, another dimension of the zones 705 may be adjusted based on the curvature of the autonomous work vehicle 600. For example, the width of any and/or all of the zones 705 may be adjusted depending on the amount of curvature. The width may increase as the angle of curvature increases, enabling the autonomous work vehicle 600 to identify more obstacles as belonging to a zone when the end position of the autonomous work vehicle 600 may be less determined. In other embodiments, the length of any and/or all of the zones 705 may be adjusted depending on the amount of curvature.

In some embodiments, a dimension of the principal zones described above may be adjusted based on the curvature of the autonomous work vehicle 600 in manner similar to the extension zones described above, in a manner consistent with description regarding FIGS. 10 and 11.

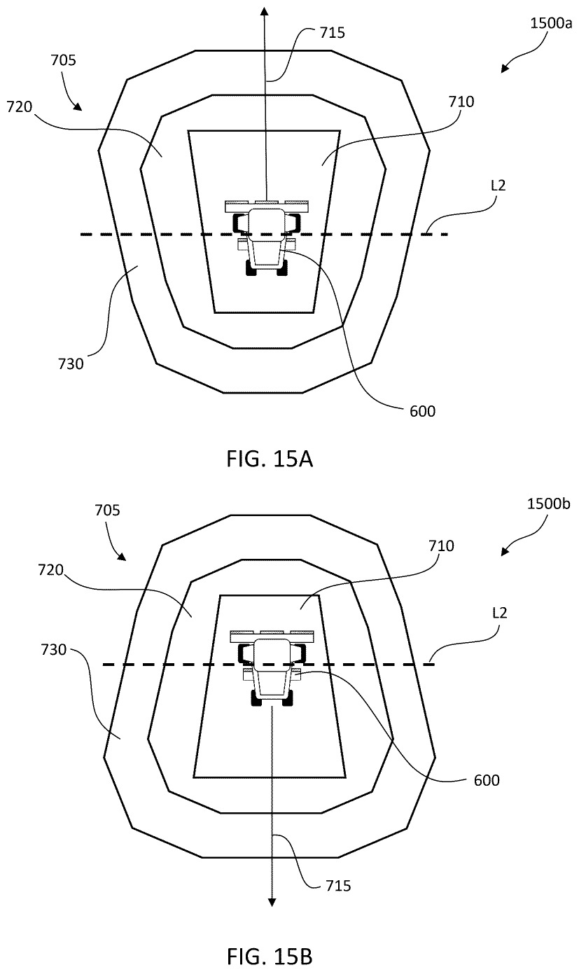

FIGS. 15A and 15B illustrate mirrored zone diagrams 1500a, 1500b. Specifically, an orientation of the zones 705 may be mirrored about the lateral axis L2 based on the driving direction of the autonomous work vehicle 600. When in the forwards driving direction (as seen in FIG. 15A) the zones 705 may have their most typical orientation, such that the zones 705 can extend furthest from the front end 612 of the autonomous work vehicle 600 and may have a width that is greatest towards the front limit of the zones 705. This may enable the autonomous work vehicle 600 to identify obstacles further in front of the autonomous work vehicle 600 as belonging or falling within a zone of the zones 705. This may provide the autonomous work vehicle 600 with more time to react to obstacles and towards which the autonomous work vehicle 600 is traveling. Because the autonomous work vehicle 600 is traveling away from obstacles located towards the rear end 614 of the vehicle 600, less time may be necessary as time may be gained as the autonomous work vehicle 600 travels away from the obstacle.

However, when the driving direction is inverted, such that the autonomous work vehicle 600 is driven in reverse, the zones 705 may be mirrored about the lateral axis L2 of the autonomous work vehicle 600. In this manner, the zones 705 may extend furthest from the rear end 614 of the autonomous work vehicle 600 and the width of the zones 705 may be greatest towards the rear limit of the zones 705. This may enable the autonomous work vehicle 600 to identify obstacles further behind the autonomous work vehicle 600 as belonging or falling within a zone of the zones 705 and provide the autonomous work vehicle 600 with more time to react and/or respond when an obstacle is detected within the zones 705. In some embodiments, only some of the zones 705 may be mirrored about the lateral axis L2, such as one zone, a minority of zones 705, or a majority of zones 705 may be mirrored about the lateral axis L2 when the autonomous work vehicle 600 is driven in reverse.

When an obstacle is identified as falling or belonging in a zone the autonomous work vehicle 600 may respond according to a response set. Each response set may include a list of actions that the autonomous work vehicle 600 may perform. An obstacle may fall in one or more zones 705, especially when the zones 705 overlap or when an obstacle extends over the limit between adjacent zones, and may thus prompt multiple sets of responses.

The responses may include sending an alert or warning perceptible within the range of the zone, such as a beacon or light beam (e.g., a continuous or flashing light), including single or multi-colored lights, such as a blinking red and/or yellow light. The alert or warning may include a noise or audio alarm configured to draw attention to animate objects to the autonomous work vehicle 600 and to signal that the autonomous work vehicle 600 should be avoided. For example, the noise or audio alarm may comprise a siren, a horn, beeping, or playing a sound recording. In some embodiments, the alert may comprise an alert to a remote operator, for example, to notify an alert operator that an obstacle is present within a vicinity of the autonomous work vehicle 600, or may comprise a camera image depicting the obstacle to enable the remote operator to view the obstacle and determine if additional action by the autonomous work vehicle should be taken.

Other responses may include slowing the autonomous work vehicle 600 to a target velocity (wherein different zones may have different target velocities), slowing the autonomous work vehicle 600 at a target deceleration (wherein different zones may have different target decelerations), stopping the autonomous work vehicle 600 (e.g., stopping the autonomous work vehicle 600 as quickly as possible), or changing a direction of the autonomous work vehicle 600 (e.g., to avoid the obstacle). The autonomous work vehicle may respond by slowing to a target velocity and/or at a target deceleration based on the position of the obstacle relative to one or more zones 705 and/or on the expectation of an obstacle entering one or more zones 705.

Still other responses may include controlling an implement connected to the autonomous work vehicle 600, such as inactivating or shutting down the implement (e.g., preventing an implement comprising a mower reel from turning) or changing a position of the implement (e.g., positioning the implement out of reach of the obstacle and/or returning the implement to a home or safe position).

In some embodiments, detection of the obstacle (either within a zone or along or near the selected path) may stimulate a “Vehicle at Distance” (VaD) response, wherein the velocity of the autonomous work vehicle 600 is adjusted to intercept the obstacle before it intersects (i.e., contacts or enters) a zone 705. That is the velocity of the autonomous work vehicle 600 may be adjusted based on the expectation that the obstacle will enter a zone 705.

For example, the visual sensor signal data may be used to indicate a distance (e.g., a down-path distance) between the obstacle and the autonomous work vehicle 600 (i.e., the obstacle distance). The visual sensor signal data may also indicate the absolute velocity of the obstacle (i.e., the obstacle velocity), and/or the velocity of the obstacle relative to the autonomous work vehicle 600 (i.e., the relatively obstacle velocity). The autonomous work vehicle 600 may then calculate a velocity trajectory (i.e., an adjustment from a first velocity of the autonomous work vehicle to a second velocity) needed to, for example, slow the velocity of the autonomous work vehicle 600 to the target velocity (e.g., a zero or non-zero velocity) corresponding to the response set of the zone by the time or before the obstacle reaches an outer limit of the zone 705 (or a buffer distance separating the obstacle and the zone 705).

A deceleration profile may comprise one or more velocity trajectories implemented by the autonomous work vehicle 600 to achieve the desired target velocity. The velocity of the autonomous work vehicle 600 need not be adjusted immediately. The response may comprise calculating a time at which the slowing of the autonomous work vehicle velocity needs to begin to effectively slow the autonomous work vehicle 600 to the target velocity. The autonomous work vehicle 600 may begin to decelerate (or otherwise adjust velocity) any time between detection of the obstacle and the point at which the autonomous work vehicle 600 needed to begin maximum deceleration to slow to the target velocity.

The severity of the response set may increase as obstacles are identified with zones located closer to the autonomous work vehicle 600, such that obstacles identified in zones located closer to the autonomous work vehicle 600 or having outer limits closer to the autonomous work vehicle 600 prompt responses that are more likely to delay or interrupt the performance of the operational task. Generally, warnings (e.g., lights or alarms) are less likely to delay or interrupt the performance of the operational task than adjusting the velocity or driving direction of the autonomous work vehicle 600 or adjusting the position or use of an implement, though delays and interruptions will depend on the nature of the operational task to be performed.

Returning to FIG. 7, the zones 705 may each correspond to a response set that increases in severity as an obstacle is detected closer and closer to the autonomous work vehicle 600. First zone 710 may comprise an occlusion zone, second zone 720 may comprise a hazard zone, third zone 730 may comprise a slowing zone, and fourth zone 740 may comprise a warning zone. The warning zone may be associated with a response set that includes instructing an alert control system to send a warning (e.g., a light and/or an alarm) perceptible within the warning zone. The slowing zone may be associated with a response set that includes slowing the autonomous work vehicle to a first target velocity. The hazard zone may be associated with a response set that includes slowing the autonomous work vehicle to a second target velocity, which may be a velocity slower than the first target velocity. Finally, the occlusion zone may be associated with a response set that includes stopping the autonomous work vehicle 600.

As the autonomous work vehicle 600 travels towards an obstacle along selected path 715, the obstacle may proceed through the zones on the order of warning zone (fourth zone 740), the slowing zone (third zone 730), the hazard zone (second zone 720), and finally the occlusion zone (first zone 710). As the obstacle comes within the limits of the warning zone, the autonomous work vehicle 600 may begin by sending a warning. As the obstacle enters the slowing zone, the autonomous work vehicle system may begin to slow a velocity of the autonomous work vehicle 600 to avoid the obstacle, slowing the autonomous work vehicle 600 to the first target velocity. When the obstacle enters the hazard zone the autonomous work vehicle system may respond by slowing the autonomous work vehicle 600 to the second target velocity. Finally, when the obstacle enters the occlusion zone (much of which may be hidden or occluded from the visual sensor field of view by portions of the autonomous work vehicle 600), the autonomous work vehicle system may slow the vehicle 600 to a stop to minimize harm to the obstacle and/or autonomous work vehicle 600.

The responses described above may replace or supplement the response sets associated with the zones. For example, the response set associated with the hazard zone may include slowing the autonomous work vehicle at a greater deceleration than in that in the slowing zone. In another example, when the obstacle enters the hazard zone the autonomous work vehicle 600 may respond by additionally, or alternatively adjusting a position of an implement connected to the autonomous work vehicle 600.

The described proportional responses may enable the autonomous work vehicle to respond with increasing levels of severity to differing levels of risk. As the obstacle comes in closer proximity to the autonomous work vehicle 600 and the risk of harm to the obstacle and/or vehicle 600 increases. This may enable the autonomous work vehicle 600 to distinguish among acceptable levels of risk and to continue to perform the operational task when the risk to obstacle and vehicle 600 is low, saving operation time and improving vehicle operational efficiency.

The zones 705 may be disposed “around” (i.e., within a vicinity or in proximity to) the autonomous work vehicle 600. As disclosed previously in FIGS. 7-11 , this may be achieved with zones 705 that each surround the autonomous work vehicle 600. Additionally, or alternatively, as seen in FIGS. 12-14 , one or more of the zones 705 may extend along a selected or selected path of the autonomous work vehicle 600.

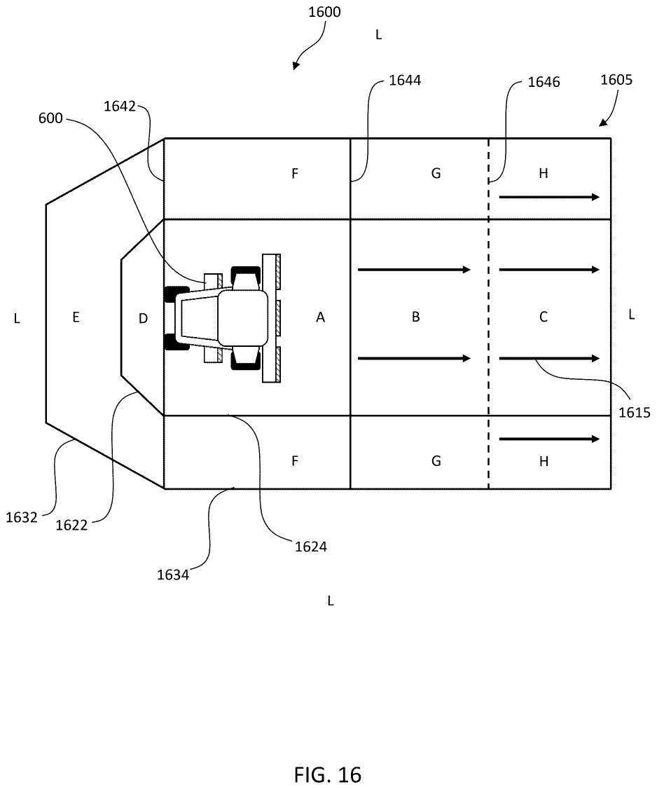

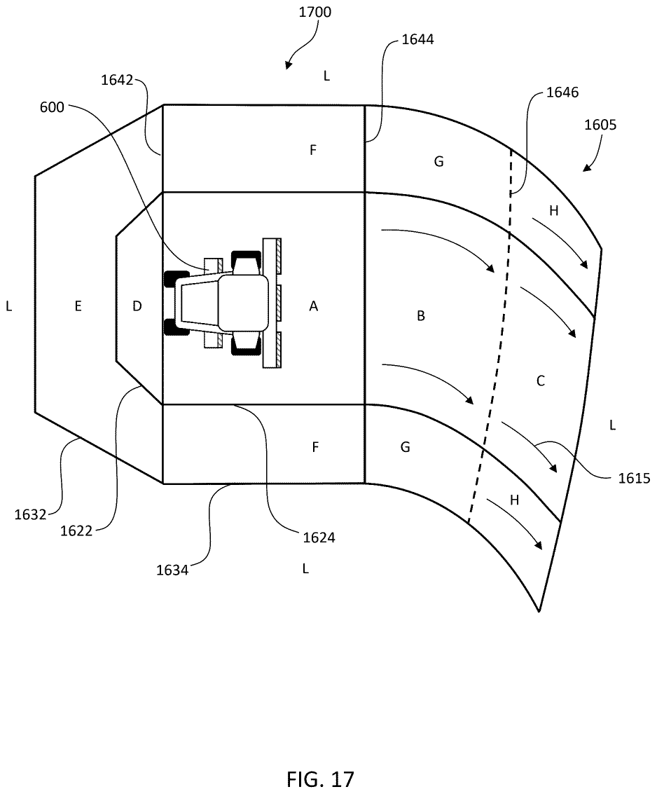

FIGS. 16-17 show zone diagrams 1600, 1700 and illustrate that one or more zones 1605 may extend along a selected path and/or may extend parallel (whether co-linearly or lateral) to the selected path. For example, zones A, B, and C may encompass portions of the operating environment located along the selected path 1615. Specifically, visual sensor signal data (e.g., point cloud data) associated with the area immediately around and in front of the autonomous work vehicle 600 and extending between the limits 1624, 1642, 1644 may correspond to zone A. Visual sensor signal data (e.g., point cloud data) associated with zone B may correspond to regions of the operating environment located immediately in front of that of zone A lying along the selected path 1615 between the limits 1624, 1644, 1646. Similarly, visual sensor signal data (e.g., point cloud data) associated with zone C may correspond to regions of the operating environment located immediately in front of that of zone B lying along the selected path 1615.

Zones F, G, and H may be associated with visual sensor signal data (e.g., point cloud data) that correspond to regions of the operating environment that lie lateral to zones A, B, and C, extending between the outer limits 1624, 1634. Zones F, G, and H may extend parallel and to the side of zones A, B, and C as well as the selected path 1615. Zones D and E may extend behind the autonomous work vehicle 600, with zone D lying immediately behind the autonomous work vehicle 600 and defined by outer limit 1622 and zone E extending further rearward behind the autonomous work vehicle 600 up to rear limit 1632. Region L may refer to regions of the operating environment lying outside the zones 1605.

Similar to zones 705 described above, in some embodiments the zones 1605 may overlap and obstacles detected within multiple zones 1605 may stimulate responses associated with each of the multiple zones 1605 within which the obstacle is detected. In particular, zones 1605 may overlap with adjacent lying zones 1605. For example, zone H may overlap with zone C over the entire area of zone C, zone G may overlap with zone B over the entire area of zone B, zone F may overlap with zone A over the entire area of zone A, and zone E may overlap with zone D over the entire area of zone D.

The shape of each zone of zones 1605 may form a polygon in a manner similar as zones 710, 720, 730, 740, 1225, 1235 described above. Specifically, zones A, B, C, F, G, and H can form a rectangle, while zones D can form a trapezoid, and zone E can form a shape resembling a trapezoid excluding the region of zone D. In other embodiments, each and/or any of zones A, B, C, D, E, F, G, and/or H may form a shape resembling a quadrilateral (e.g., square, rhomboidal), round (e.g., circular, elliptical, oval), triangular, or pentagonal profile, or other polygonal profile.

Similar to that described above, the shape of the zones 1605 may be based on the shape or boundary of zones 1605 lying closer to the autonomous work vehicle 600. For example, the outer limit 1634 of zones G and/or H may extend from the position of the outer limit 1634 delimiting the boundary of zone F, and outer limit 1624 of zones B and/or C may extend from the position of the outer limit 1624 delimiting the boundary of zona A. Similar as described above, the dimensions of the frontward zones B, C, G, and H may be adjusted based on the curvature of the selected path 1615 and/or of the instantaneous curvature of the autonomous work vehicle (see FIG. 17).

Zones A, B, C, and D may constitute “interior zones,” while zones E, F, G, and H may constitute “exterior zones,” with the exterior zones extending alongside and surrounding the interior zones. The exterior zones may be primarily associated with a response set comprising warnings, while the interior zones may additionally, or alternatively, comprise velocity, steering, and/or implement activation or positional adjustments to avoid or minimize the risk of contact with an obstacle.

For example, if an obstacle enters zone E, F, G, or H, the alert control system of the autonomous work vehicle 600 may be instructed to send a warning, such as a flashing light. As the distance between the obstacle and the autonomous work vehicle 600 shortens the response set associated with the zone may escalate (i.e., become more noticeable to a person within the zone and/or to slow or stop operation of the autonomous work vehicle 600). For example, the light may be accompanied with an alarm, the lights may become brighter, and/or the alarm may become louder as the distance between the obstacle and the autonomous work vehicle 600 shortens. When the obstacle enters zone G, the autonomous work vehicle 600 may be instructed to respond with both a flashing light and an alarm. When an obstacle enters zones E or F, the autonomous work vehicle 600 may be instructed to responds with both a flashing light and an alarm at a volume that is louder than the alarm associated with zone G.

When the obstacle enters an interior zone (i.e., zone A, B, C, or D) the autonomous work vehicle 600 may be respond with one of several motor actions. For example, when an obstacle enters any one of the interior zones the autonomous work vehicle 600 may slow a velocity of the autonomous work vehicle 600 (e.g., to a target velocity), slow the autonomous work vehicle 600 at a target deceleration, stop the autonomous work vehicle 600, deactivate an implement, adjust a position of an implement, or select another path to follow (e.g., so as to avoid the obstacle).

The response(s) associated with the interior zones may also escalate as the distance between an obstacle and the autonomous work vehicle 600 decreases. For example, when the obstacle is detected within zone C the autonomous work vehicle 600 may slow at a first deceleration, when the obstacle is detected within zone B the autonomous work vehicle 600 may slow at a second deceleration greater than the first deceleration, and when the obstacle is detected in zone A or D the autonomous work vehicle may slow at a maximum deceleration to stop immediately.

In another example, the response associated with the interior zones may include slowing the autonomous work vehicle 600 to a target velocity. Specifically, when the obstacle is detected within zone C the autonomous work vehicle may determine a first deceleration (e.g., based on a known velocity of the autonomous work vehicle 600 and/or a velocity of the obstacle, or a velocity of the autonomous work vehicle 600 relative to the obstacle) needed to slow the autonomous work vehicle 600 to a first velocity when the obstacle reaches limit 1646 (i.e., before the obstacle enters zone B). The autonomous work vehicle 600 may then slow at the first deceleration (e.g., via the speed control system). When the obstacle is detected within zone B the autonomous work vehicle may then similarly determine a second deceleration needed to the slow the autonomous work vehicle to a second velocity slower than the first velocity, such as a velocity of 0 mph, when the obstacle reaches limit 1644 (i.e., before the obstacle enters zone A). The autonomous work vehicle 600 may then slow at the second deceleration.

While in some embodiments the response set associated with the exterior zones may comprise only warnings, in other embodiments the response set associated with any one of the exterior zones may additionally, or alternatively, comprise a motor action (i.e., a response that adjusts a velocity, steering direction, or movement of a vehicle or implement surface), such as slowing the velocity of the autonomous work vehicle 600, stopping the autonomous work vehicle 600, deactivating the implement, adjusting a position of the implement, or selecting another path for the autonomous work vehicle 600 to follow. Compared to warnings, such motor actions may reduce the risk of harm or injury to a greater extent, but may also interfere with the operational task (e.g., to slow, impede, or terminate the successful completion of the operational task).

The autonomous work vehicle 600 may employ more moderate (i.e., smaller) deceleration rates for obstacles located to the side or rear of the autonomous work vehicle 600, but may employ greater deceleration rates when the obstacle enters an interior zone, and thereby enabling a measured response of the autonomous work vehicle. For example, the response sets of both the interior zones and the exterior zones may include responses for slowing to a target velocity. In some embodiments, the target velocity of the exterior zones may be greater than the target velocity of the interior zones.

For example, the autonomous work vehicle 600 may be slowed to a first (non-zero) target velocity when an obstacle is detected within or intersects zone C, may be slowed to a second (non-zero) target velocity slower than the first target velocity when the obstacle is detected within or intersects zone B (e.g., when the obstacle intersects limit 1646), and may be slowed to a stop when the obstacle is detected within or intersects zone A (e.g., when the obstacle intersects limit 1644) (In this example, zone A comprises a “stopping zone.”) The exterior zones may also induce slowing of the autonomous work vehicle 600 upon detection of the obstacle, but may correspond to more moderate deceleration or velocity adjustments, such that the autonomous work vehicle 600 may respond more moderately or with less velocity change than compared to the responses corresponding to the interior zones. For example, the autonomous work vehicle 600 may be slowed to a third (non-zero) target velocity greater than the first target velocity when the obstacle is detected within or intersects zone H, may be slowed to fourth (non-zero) velocity greater than the second target velocity but less than the third target velocity when the obstacle is detected within or intersects zone G, and may be slowed to a fifth (non-zero) target velocity less than the fourth velocity when the obstacle is detected within or intersects zone F. In this manner, the autonomous work vehicle 600 may slow without stopping when an obstacle is detected within the exterior zones, but not the interior zones, until the autonomous work vehicle 600 has passed the obstacle.

The response set of interior zones may also comprise warnings activated by the autonomous work vehicle 600, such as activating an alarm or lights of the autonomous work vehicle 600. Similar to that described above, the zones may be mirrored about a lateral axis L2 of the autonomous work vehicle 600 when the autonomous work vehicle 600 is driven in reverse. In such instances, zones B, C, G, and H would be positioned behind the vehicle 600, and zones D and E would be disposed in front of the vehicle 600.

Because the exterior zones may be located a minimum distance from the autonomous work vehicle 600 and/or the selected path 1615, obstacles that enter or are present in exterior zones may not be treated with high concern or priority, and may trigger only low-intensity responses from the vehicle 600 (e.g., marginal slowing or other responses that do not stop the autonomous work vehicle 600 or the operational task). This may be because obstacles present in exterior zones are not within the swept path (i.e., the portion of the ground surface of the operating environment selected to come in contact with the autonomous work vehicle 600 and/or the implement) of the autonomous work vehicle 600.

Additionally, or alternatively, portions or the operating environment which are occluded from the visual sensor field of view may be treated differently when disposed within an exterior zone than when disposed within an interior zone. For example, an occluded portion of the operating environment present within zones A, B, and/or C may cause the autonomous work vehicle 600 to respond by slowing and/or stopping completely arriving at the occluded portion, while an occluded portion of the operating environment present within zones F, G, and/or H may cause the autonomous work vehicle 600 to respond by slowing or by not slowing, while continuing to perform the operational task. A similar configuration may apply to embodiments described regarding FIGS. 7-15. For example, occlusions present in zones 720 and/or 1225 may cause the autonomous work vehicle 600 to slow and/or stop, while occlusions present in zones 730 and/or 1235 may cause the autonomous work vehicle to respond by slowing (e.g., slowing slightly) or not slow, while continuing to perform the operational task.

Numerous specific details are set forth herein to provide a thorough understanding of the claimed subject matter. However, those skilled in the art will understand that the claimed subject matter may be practiced without these specific details. In other instances, methods, apparatuses or systems that would be known by one of ordinary skill have not been described in detail so as not to obscure claimed subject matter.

Some portions are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is a self-consistent sequence of operations or similar processing leading to a desired result. In this context, operations or processing involves physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general-purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied - for example, blocks can be re-ordered, combined, and/or broken into sub-blocks. Certain blocks or processes can be performed in parallel.

Unless otherwise specified, the term “substantially” means within 5% or 10% of the value referred to or within manufacturing tolerances. Unless otherwise specified, the term “about” means within 5% or 10% of the value referred to or within manufacturing tolerances.

The terms “first”, “second”, “third”, etc. are used to distinguish respective elements and are not used to denote a particular order of those elements unless otherwise specified or order is explicitly described or required.

The conjunction “or” is inclusive.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation, and does not preclude inclusion of such modifications, variations and/or additions to the present subject matter as would be readily apparent to one of ordinary skill in the art.

That which is claimed:

1. An autonomous work vehicle comprising:
a steering control system for autonomously controlling a driving direction of the autonomous work vehicle;
a speed control system for autonomously controlling a speed of the autonomous work vehicle;
an alert control system for autonomously controlling warning signals of the autonomous work vehicle;
one or more sensors, including a visual sensor;
one or more processors communicatively coupled with the one or more sensors, the steering control system, the speed control system, and the alert control system; and
one or more computer-readable media having stored thereon instructions that when executed cause the one or more processors to:
receive visual sensor signal data from the visual sensor in predetermined time packets, wherein the visual sensor signal data comprises data points of a virtual space that represents at least a portion of an operating environment;
assign a subset of the data points of the visual sensor signal data to a series of nested zones, wherein the series of nested zones surrounds a portion of the virtual space representing a space occupied by the autonomous work vehicle, wherein the series of nested zones includes, in order of increasing size, an occlusion zone, a hazard zone, a slowing zone, and a warning zone, and wherein the portion of the virtual space representing the space occupied by the autonomous work vehicle is surrounded by each zone of the series of nested zones; and
instruct the autonomous work vehicle to drive at a first velocity;
instruct the autonomous work vehicle to respond when the visual sensor signal data indicates that an obstacle is present within a zone of the series of nested zones, such that:
when the visual sensor signal data indicates that an obstacle is present within the warning zone, instruct the alert control system to send a light beam or an audio alarm perceptible within the warning zone;
when the visual sensor signal data indicates that an obstacle is present within the slowing zone, instruct the speed control system to slow a velocity of the autonomous work vehicle to a second velocity less than the first velocity;
when the visual sensor signal data indicates that an obstacle is present within the hazard zone, instruct the speed control system to slow a velocity of the autonomous work vehicle to a third velocity less than the second velocity; and
when the visual sensor signal data indicates that an obstacle is present within the occlusion zone, instruct the speed control system to stop the autonomous work vehicle.

2. The autonomous work vehicle of claim 1, wherein the instructions further cause the one or more processors to adjust a dimension of a zone of the series of nested zones based on the velocity and/or curvature of the autonomous work vehicle.

3. The autonomous work vehicle of claim 1, wherein the instructions further cause the one or more processors to instruct the speed control system to slow the velocity of the autonomous work vehicle at a greater deceleration in the hazard zone than in the slowing zone.

4. The autonomous work vehicle of claim 1, wherein the audio alarm comprises a siren, a sound recording, or a horn of the autonomous work vehicle, and the light beam comprises a flashing light or a continuous light.

5. The autonomous work vehicle of claim 1, wherein the instructions further cause the one or more processors to adjust a position of an implement connected to the autonomous work vehicle when an obstacle enters the hazard zone.

6. The autonomous work vehicle of claim 1, wherein an outer limit of at least one zone of the series of nested zones is spaced from the autonomous work vehicle by a set distance along a circumference of the autonomous work vehicle, such that the outer limit of the at least one zone resembles a top-view profile of the autonomous work vehicle.

7. The autonomous work vehicle of claim 1, wherein an orientation of the series of nested zones is mirrored about a lateral axis of the autonomous work vehicle when the autonomous work vehicle is driven in reverse.

8. An autonomous work vehicle comprising:
a steering control system for autonomously controlling a driving direction of the autonomous work vehicle;
a speed control system for autonomously controlling a speed of the autonomous work vehicle;
one or more sensors, including a visual sensor;
one or more processors communicatively coupled with the one or more sensors, the steering control system, and the speed control system; and
one or more computer-readable media having stored thereon instructions that when executed cause the one or more processors to:
receive visual sensor signal data from the visual sensor in predetermined time packets, wherein the visual sensor signal data comprises data points of a virtual space that represents at least a portion of an operating environment;
assign a subset of the data points of the visual sensor signal data to a zone within the operating environment, wherein the zone surrounds a portion of the virtual space representing a space occupied by the autonomous work vehicle;
adjust a dimension of the zone based on a velocity and/or curvature of the autonomous work vehicle; and
instruct the speed control system to adjust a velocity of the autonomous work vehicle when an obstacle is detected within the zone.

9. The autonomous work vehicle of claim 8, wherein the zone forms part of a series of nested zones surrounding the autonomous work vehicle, and wherein the instructions cause the one or more processors to instruct the autonomous work vehicle to provide a different set of responses based on the zone within which the obstacle is detected.

10. The autonomous work vehicle of claim 8, wherein the instructions further cause the one or more processors to adjust a position of an implement connected to the autonomous work vehicle when an obstacle is detected within the zone.

11. The autonomous work vehicle of claim 8, wherein the instructions further cause the one or more processors to adjust a dimension of the zone based on a position of an implement connected to the autonomous work vehicle.

12. The autonomous work vehicle of claim 8, wherein the instructions further cause the one or more processors to mirror an orientation of the zone about a lateral axis of the autonomous work vehicle when the autonomous work vehicle is driven in reverse.

13. The autonomous work vehicle of claim 8, wherein the autonomous work vehicle comprises an autonomous mower.

14. An autonomous work vehicle comprising:
a steering control system for autonomously controlling a driving direction of the autonomous work vehicle;
a speed control system for autonomously controlling a speed of the autonomous work vehicle;
one or more sensors, including a visual sensor;
one or more processors communicatively coupled with the one or more sensors, the steering control system, and the speed control system; and
one or more computer-readable media having stored thereon instructions that when executed cause the one or more processors to:
receive visual sensor signal data from the visual sensor in predetermined time packets, wherein the visual sensor signal data comprises data points of a virtual space that represents at least a portion of an operating environment;
define a first zone represented by a first polygon that surrounds a first portion of the virtual space corresponding to a space occupied by the autonomous work vehicle and assign a first subset of the data points to the first zone;
define a second zone represented by a second polygon that surrounds the first portion of the virtual space corresponding to the space occupied by the autonomous work vehicle and assign a second subset of the data points to the second zone, wherein the second polygon has a smaller area than the first polygon;
when an obstacle is detected within the first zone, instruct the speed control system to automatically slow the autonomous work vehicle; and
when an obstacle is detected within the second zone, instruct the speed control system to automatically stop the autonomous work vehicle.

15. The autonomous work vehicle of claim 14, wherein the instructions further cause the one or more processors to adjust a dimension of the first and/or second zone based on a velocity of the autonomous work vehicle.

16. The autonomous work vehicle of claim 14, wherein the instructions further cause the one or more processors to adjust a dimension of the first and/or second zone based on a curvature of the autonomous work vehicle.

17. The autonomous work vehicle of claim 14, wherein the instructions further cause the one or more processors to mirror the first and/or second zones about a lateral axis of the autonomous work vehicle when driven in reverse.

18. The autonomous work vehicle of claim 14, wherein the instructions further cause the one or more processors to:
define a third zone represented by a third polygon that surrounds a second portion of the virtual space corresponding to at least a space extending along or to a side of a selected path of the autonomous work vehicle; and
when an obstacle is detected within the third zone, instruct the speed control system to slow a velocity of the autonomous work vehicle to a target velocity before the obstacle enters the first zone.

19. The autonomous work vehicle of claim 14, wherein the instructions further cause the one or more processors to:
define a third zone represented by a third polygon that surrounds the first and second zones; and
when an obstacle is detected within the first zone, instruct the speed control system to slow a velocity of the autonomous work vehicle at a greater deceleration in the first zone than when an obstacle is detected within the third zone.

20. The autonomous work vehicle of claim 14, wherein the instructions further cause the one or more processors to adjust a position of an implement connected to the autonomous work vehicle when an obstacle enters the second zone.

21. The autonomous work vehicle of claim 14, wherein the instructions further cause the one or more processors to shut down the autonomous work vehicle and/or an implement connected to the autonomous work vehicle when an obstacle enters the second zone.
